(19) United States
(12) Patent Application Publication
(10) Pub. No.: US 2013/0321367 A1
(43) Pub. Date: Dec. 5, 2013

(54) DISPLAY DEVICE

(71) Applicant: Nobuhiro Kuwabara, Osaka-shi (JP)

(72) Inventor: Nobuhiro Kuwabara, Osaka-shi (JP)

(73) Assignee: Sharp Kabushiki Kaisha, Osaka-shi, Osaka (JP)

(21) Appl. No.: 13/985,753

(22) PCT Filed: Feb. 10, 2012
(86) PCT No.: PCT/JP2012/053089

§ 371 Date: Aug. 15, 2013

(30) Foreign Application Priority Data
Feb. 17, 2011 (JP) 2011-032563

(51) Int. Cl. G09G 3/36

(52) U.S. Cl. CPC G09G 3/3655
USPC 345/205; 345/58

(57) ABSTRACT

A display panel of a liquid crystal display device includes smoothing parts provided on an output end side of auxiliary capacitance lines. Through the smoothing parts, the auxiliary capacitance lines arranged along scanning signal lines and a common electrode are connected to each other. The smoothing parts each have a correction TFT and a capacitor. A source electrode of the correction TFT and each of the auxiliary capacitance lines are connected to each other, and a drain electrode and the common electrode are connected to each other through each of the capacitors. The correction TFT is controlled so as to enter a conductive state when the scanning signal line is in a selected state, and enter a shut state when the scanning signal line is in a non-selected state.

### RELATED APPLICATIONS

The present application is a National Phase of International Application Number PCT/JP2012/053089, filed Feb. 10, 2012, and which is based upon and claims the benefit of priority from Japanese Patent Application No. 2011-032563, filed on Feb. 17, 2011.

### TECHNICAL FIELD

The present invention relates to a display device, and particularly, to an active matrix-type display device using switching elements such as thin film transistors.

### BACKGROUND ART

In recent years, an active matrix-type display device such as a liquid crystal display device and an organic EL display device has been widely prevalent. Particularly, a liquid crystal display device in which a switching element such as a thin film transistor (TFT) is provided in each pixel circuit has attracted attention, because a display image with less crosstalk can be obtained even if the number of pixels is increased.

The active matrix-type liquid crystal display device has conventionally been required to reduce power consumption. As one of methods for reducing the power consumption, there has been known a method of performing reverse polarity driving by changing a potential of a corresponding auxiliary capacitance line after a selection period of each scanning signal line has ended. According to the driving method, since a large voltage can be applied to a liquid crystal layer with a small data signal amplitude, the power consumption can be reduced. The driving method has been disclosed, for example, in Patent Documents 1 to 3.

Incidentally, in each of the pixel circuits, an auxiliary capacitance is formed by a pixel electrode and the auxiliary capacitance line. Fluctuation of a pixel potential generated when a data signal is written to the pixel electrode is transmitted to the auxiliary capacitance line through the auxiliary capacitance or the like, by which a potential of the auxiliary capacitance line is fluctuated. As a result, the pixel potential has a different value from that of a potential to be originally retained. Particularly, in the conventional liquid crystal display device using the method of changing the potential of the corresponding auxiliary capacitance line after the selection period of each of the scanning signal lines has ended to thereby perform the reverse polarity driving, an impedance is raised by a switch or the like to switch the potential of the auxiliary capacitance line, which makes it difficult for the fluctuated potential of the auxiliary capacitance line to return to the original potential. Therefore, particularly, in the conventional liquid crystal display device using the method of changing the potential of the corresponding auxiliary capacitance line after the selection period of each of the scanning signal lines has ended to thereby perform the reverse polarity driving, there is a problem that crosstalk in a horizontal direction (hereinafter, referred to as “horizontal crosstalk”) is caused, so that display quality is deteriorated.

In relation to the invention of the present application, in Patent Document 4, there has been disclosed a liquid crystal display device in which a bypass capacitance is formed between an auxiliary capacitance line and a counter electrode in each pixel circuit, and a resistive element is provided between an auxiliary capacitance line group (bus wiring) and a counter electrode group (bus wiring). According to the configuration, since a potential obtained by dividing an auxiliary capacitance potential by the pixel capacitance and the bypass capacitance is supplied as a counter potential, and further, a value of the resistive element is sufficiently large, the counter potential is not affected by the auxiliary capacitance potential. Accordingly, utilizing the auxiliary capacitance line having a small time constant and the auxiliary capacitance potential, the counter potential can be stabled.

In relation to the invention of the present application, in Patent Document 5, there has been disclosed a liquid crystal display device in which auxiliary capacitance joining lines that each have a low resistance and mutually join a plurality of auxiliary capacitance lines are provided. According to the configuration, electric charge can be supplied from other auxiliary capacitance lines through the auxiliary capacitance joining line to the auxiliary capacitance line with the potential fluctuated, by which the potential fluctuation can be suppressed. In addition, means for suppressing deterioration in display quality relating to the invention of the present application or the like has been disclosed, for example, in Patent Documents 6 to 8.

### PRIOR ART DOCUMENTS

### Patent Documents

[Patent Document 1] Japanese Laid-Open Patent Publication No. 2006-220947

[Patent Document 2] Japanese Laid-Open Patent Publication No. 2002-196358

[Patent Document 3] Japanese Laid-Open Patent Publication No. 2007-47220

[Patent Document 4] Japanese Laid-Open Patent Publication No. H2-291520

[Patent Document 5] Japanese Laid-Open Patent Publication No. 2003-43948

[Patent Document 6] Japanese Laid-Open Patent Publication No. H7-218930

[Patent Document 7] Japanese Laid-Open Patent Publication No. 2004-85891

[Patent Document 8] Japanese Patent No. 4633121

### SUMMARY OF THE INVENTION

### Problems to be Solved by the Invention

However, in the configuration of the liquid crystal display device according to Patent Document 4, since the plurality of auxiliary capacitance lines are mutually connected by the auxiliary capacitance line group (bus wiring) at all times, the respective auxiliary capacitance lines cannot be driven independently. Thus, the configuration cannot be employed for the liquid crystal display device using the method of changing the potential of the corresponding auxiliary capacitance line after the selection period of each of the scanning signal lines has ended to thereby perform the reverse polarity driving.

In the configuration of the liquid crystal display device according to Patent Document 5 as well, since the plurality of auxiliary capacitance lines are mutually connected through the auxiliary capacitance joining lines at all times, as with the configuration of the liquid crystal display device according to Patent Document 4, the respective auxiliary capacitance lines cannot be driven independently. Thus, the configuration cannot be employed for the liquid crystal display device using the method of changing the potential of the corresponding auxiliary capacitance line after the selection period of each of the scanning signal lines has ended to thereby perform the reverse polarity driving, either.

Therefore, an object of the present invention is to provide a display device that can suppress horizontal crosstalk while reducing power consumption.

### Means for Solving the Problems

According to a first aspect of the present invention, there is provided a display device, including: a plurality of data signal lines to which a plurality of data signals that represent an image to be displayed are applied, respectively; a plurality of scanning signal lines that intersect the plurality of data signal lines, and are driven selectively by being respectively applied a plurality of scanning signals; a plurality of pixel circuits arranged in a matrix shape, corresponding to intersections between the plurality of data signal lines and the plurality of scanning signal lines, respectively; a plurality of auxiliary capacitance lines arranged along the plurality of scanning signal lines, respectively; an auxiliary capacitance line drive circuit that applies, to the plurality of auxiliary capacitance lines, a plurality of auxiliary capacitance signals to drive the auxiliary capacitance lines independently from one another, respectively; and smoothing parts provided, corresponding to the respective scanning signal lines, wherein each of the pixel circuits includes: a first switching element that enters a conductive state when the scanning signal line passing through a corresponding intersection is in a selected state, and enters a shut state when the scanning signal line is in a non-selected state; a pixel electrode that is connected to the data signal line passing through the corresponding intersection through the first switching element; a common electrode provided commonly to the plurality of pixel circuits; and an auxiliary capacitance formed between the pixel electrode and the auxiliary capacitance line arranged along the scanning signal line passing through the corresponding intersection, after the scanning signal line is switched from the selected state to the non-selected state, the auxiliary capacitance line drive circuit changes a potential of the auxiliary capacitance signal applied to the auxiliary capacitance line arranged along the scanning signal line, each of the smoothing parts is made up of a second switching element that is controlled so as to enter a conductive state when the scanning signal line corresponding to the smoothing part is in the selected state, and enter a shut state when the scanning signal line is in the non-selected state, and a capacitive element connected to any of conduction terminals of the second switching element, and through each of the smoothing parts, the auxiliary capacitance line arranged along the scanning signal line corresponding to the smoothing part, and a wiring to which a fixed potential is supplied when the scanning signal line corresponding to the smoothing part is in the selected state are connected to each other.

According to a second aspect of the present invention, in the first aspect of the present invention, one of the conduction terminals of the second switching element in each of the smoothing parts, and the auxiliary capacitance line arranged along the scanning signal line corresponding to the smoothing part are connected to each other, and the other of the conduction terminals of the second switching element in each of the smoothing parts, and the wiring are connected to each other through the capacitive element in the smoothing part.

According to a third aspect of the present invention, in the first aspect of the present invention, one of the conduction terminals of the second switching element in each of the smoothing parts, and the auxiliary capacitance line arranged along the scanning signal line corresponding to the smoothing part are connected to each other through the capacitive element in the smoothing part, and the other of the conduction terminals of the second switching element in each of the smoothing parts, and the wiring are connected to each other.

According to a fourth aspect of the present invention, in the second or third aspect of the present invention, the wiring is the common electrode.

According to a fifth aspect of the present invention, in the second or third aspect of the present invention, the wiring is a power supply line that supplies power to generate the plurality of auxiliary capacitance signals.

According to a sixth aspect of the present invention, in the second or third aspect of the present invention, the wiring is the auxiliary capacitance line arranged along the scanning signal line in the non-selected state.

According to a seventh aspect of the present invention, in the second or third aspect of the present invention, the wiring is the scanning signal line in the selected state.

### Effects of the Invention

In any of the first to third aspects of the present invention, when the scanning signal line is in the selected state, the wiring to which the fixed potential is supplied, and the auxiliary capacitance line are electrically connected through the capacitive element in the smoothing part. Since this makes a potential fluctuation amount of the auxiliary capacitance line generated at the writing time of the data signal smaller than the conventional device, time till a potential of the auxiliary capacitance line returns to an original potential is made shorter than that in the conventional device. This prevents fluctuation of a pixel potential attributed to potential fluctuation of the auxiliary capacitance line from occurring. Moreover, since the potential of the auxiliary capacitance line is changed after the scanning signal line is switched from the selected state to the non-selected state, by which a bias voltage is applied to the pixel potential, a large voltage can be applied to a liquid crystal layer with a small data signal amplitude. Accordingly, horizontal crosstalk can be suppressed while reducing power consumption.

According to the fourth aspect of the present invention, the common electrode and the auxiliary capacitance line arranged along the scanning signal line in the selected state are connected to each other through the smoothing part, by which the potential fluctuation of the auxiliary capacitance line can be suppressed.

According to the fifth aspect of the present invention, the power supply line that supplies the power to generate the plurality of auxiliary capacitance signals, and the auxiliary capacitance line arranged along the scanning signal line in the selected state are connected to each other through the smoothing part, by which the potential fluctuation of the auxiliary capacitance line can be suppressed.

According to the sixth aspect of the present invention, the auxiliary capacitance line arranged along the scanning signal line in the non-selected state and the auxiliary capacitance line arranged along the scanning signal line in the selected state are connected to each other through the smoothing part, by which the potential fluctuation of the auxiliary capacitance line can be suppressed.

According to the seventh aspect of the present invention, the scanning signal line in the selected state and the auxiliary capacitance line arranged along the scanning signal line in the selected state are connected to each other through the smoothing part, by which the potential fluctuation of the auxiliary capacitance line can be suppressed.

### BRIEF DESCRIPTION OF THE DRAWINGS

FIG. 1 is a circuit diagram showing an electric configuration of a liquid crystal display device according to a first embodiment of the present invention.

FIG. 2 is a circuit diagram showing an electric configuration of an auxiliary capacitance line drive circuit in the first embodiment.

FIGS. 3(A) to 3(G) are voltage waveform diagrams for describing operation of the liquid crystal display device according to the first embodiment.

FIG. 4(A) is a voltage waveform diagram of a pixel potential resulting from enlarging a portion RB surrounded by a dashed line in FIG. 3(G), and FIG. 4(B) is a voltage waveform diagram of a potential of an auxiliary capacitance line resulting from enlarging a portion RA surrounded by a dashed line in FIG. 3(E).

FIG. 5 is a diagram showing an example in which a predetermined display pattern is displayed in the first embodiment.

FIGS. 6(A) to 6(D) are voltage waveform diagrams of portions corresponding to a scanning signal line GL(n) and an auxiliary capacitance line CSL(n) in the display image shown in FIG. 5.

FIGS. 7(A) to 7(D) are voltage waveform diagrams of portions corresponding to a scanning signal line GL(p) and an auxiliary capacitance line CSL(p) in the display image shown in FIG. 5.

FIG. 8 is a circuit diagram showing an example in which a connection order between a correction TFT and a capacitor is reversed in the first embodiment.

FIG. 9 is a circuit diagram showing an electric configuration of a liquid crystal display device according to a second embodiment of the present invention.

FIG. 10 is a circuit diagram for describing connections between auxiliary capacitance lines and an L-side power supply line in the second embodiment.

FIG. 11 is a circuit diagram showing an electric configuration of a liquid crystal display device according to a third embodiment of the present invention.

FIG. 12 is a circuit diagram showing an electric configuration of a liquid crystal display device according to a fourth embodiment of the present invention.

FIG. 13 is a circuit diagram showing an electric configuration of a liquid crystal display device according to basic consideration of the present invention.

FIG. 14 is a circuit diagram showing an electric configuration of a pixel circuit in the basic consideration and the first embodiment.

FIGS. 15(A) to 15(E) are voltage waveform diagrams for describing operation of the liquid crystal display device according to the basic consideration.

FIG. 16 is an equivalent circuit diagram of an auxiliary capacitance line.

FIGS. 17(A) and 17(B) are voltage waveform diagrams when return time is shorter than a writing period, FIG. 17(A) being a voltage waveform diagram of a potential of the auxiliary capacitance line resulting from enlarging a portion RA surrounded by a dashed line in FIG. 15(C), and FIG. 17(B) being a voltage waveform diagram of a pixel potential resulting from enlarging a portion RB surrounded by a dashed line in FIG. 15(E).

FIGS. 18(A) and 18(B) are voltage waveform diagrams when the return time is longer than the writing period, FIG. 18(A) being a voltage waveform diagram of the potential of the auxiliary capacitance line resulting from enlarging the portion RA surrounded by the dashed line in FIG. 15(C), and FIG. 18(B) being a voltage waveform diagram of the pixel potential resulting from enlarging the portion RB surrounded by the dashed line in FIG. 15(E).

FIGS. 19(A) to 19(D) are voltage waveform diagrams for describing operation of the liquid crystal display device according to the basic consideration in accordance with a magnitude of a potential fluctuation amount ΔV.

FIG. 20 is a diagram showing an example in which a predetermined display pattern is displayed in the liquid crystal display device according to the basic consideration.

FIGS. 21(A) to 21(D) are voltage waveform diagrams of portions corresponding to a scanning signal line GL(n) and an auxiliary capacitance line CSL(n) in the display image shown in FIG. 20.

FIGS. 22(A) to 22(D) are voltage waveform diagrams of portions corresponding to a scanning signal line GL(p) and an auxiliary capacitance line CSL(p) in the display image shown in FIG. 20.

### MODES FOR CARRYING OUT THE INVENTION

### 0. Basic Consideration

Before embodiments of the present invention are described, there will be described a basic consideration performed by the inventor of the present application in order to solve the above-described problems.

<0.1 Configuration of Conventional Liquid Crystal Display Device>

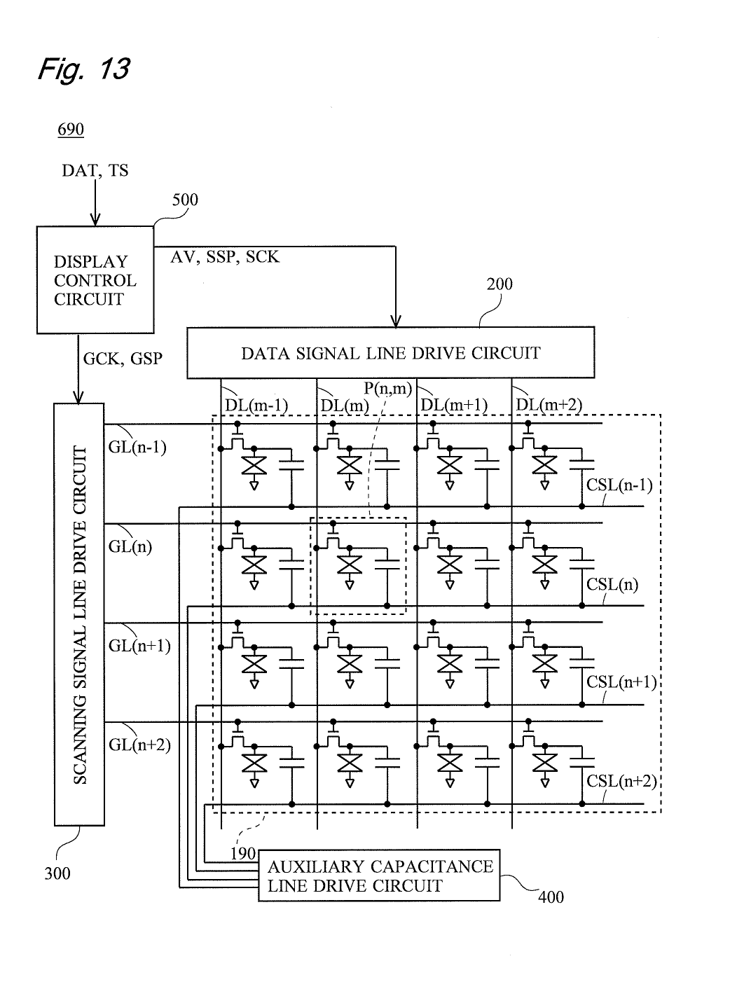

FIG. 13 is a circuit diagram showing an electric configuration of a conventional liquid crystal display device in which a potential of a corresponding auxiliary capacitance line is changed after a selection period of each scanning signal line has ended to thereby perform reverse polarity driving. As shown in FIG. 13, a conventional liquid crystal display device 690 includes a display panel 190, a data signal line drive circuit 200, a scanning signal line drive circuit 300, an auxiliary capacitance line drive circuit 400, and a display control circuit 500.

The display panel 190 is made of a pair of electrode substrates sandwiching a liquid crystal layer, and a polarizing plate is pasted to an outer surface of each of the electrode substrates. One of the pair of electrode substrates is an active matrix-type substrate called a TFT (Thin Film Transistor) substrate. In the TFT substrate, on an insulating substrate such as a glass substrate, a plurality of data signal lines DL(1) to DL(M) (hereinafter, referred to as a “data signal line(s) DL” when these are not distinguished) and a plurality of scanning signal lines GL(1) to GL(N) are formed in a lattice shape so as to cross one another, and further, a plurality of auxiliary capacitance lines CSL(1) to CSL(N) (hereinafter, referred to as an “auxiliary capacitance line(s) CSL” when these are not distinguished) are formed, the auxiliary capacitance lines CSL being arranged along the plurality of scanning signal lines GL(1) to GL(N) (hereinafter, referred to as a “scanning signal line(s) GL when these are not distinguished), respectively, and being able to be driven independently from one another. Moreover, a plurality of pixel circuits P(n, m) are formed in a matrix shape, corresponding to intersections between the plurality of data signal lines DL(1) to DL(M) and the plurality of scanning signal lines GL(1) to GL(N), respectively (n=1 to N, m=1 to M). Although for convenience of illustration, only 16 pixel circuits are shown in FIG. 13, actually, the (N×M) pixel circuits are formed on the display panel 190. The other of the pair of electrode substrates is called a counter substrate, and on an insulating substrate such as glass substrate, a common electrode and an oriented film are sequentially laminated over a whole surface. The plurality of data signal lines DL(1) to DL(M), the plurality of scanning signal lines GL(1) to GL(N) and the plurality of auxiliary capacitance lines CSL(1) to CSL(N) are driven by the data signal line drive circuit 200, the scanning signal line drive circuit 300 and the auxiliary capacitance line drive circuit 400, respectively.

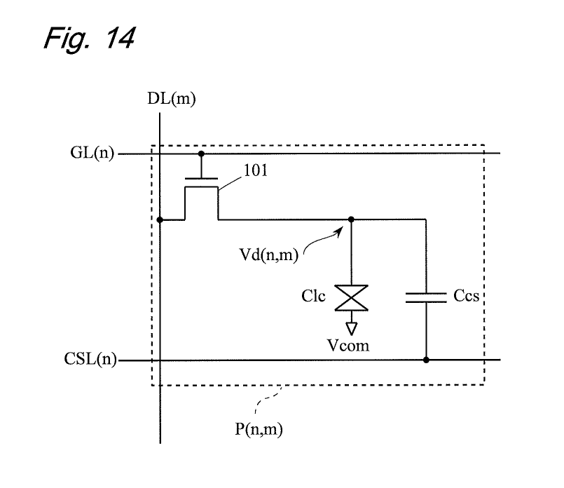

FIG. 14 is a circuit diagram showing an electric configuration of the pixel circuit P(n, m). Each of the pixel circuits P(n, m) is provided, corresponding to any one of the intersections between the plurality of data signal lines DL(1) to DL(M) and the plurality of scanning signal lines GL(1) to GL(N). Moreover, each of the pixel circuits P(n, m) includes a pixel TFT 101 as a first switching element having a source electrode connected to the data signal line DL(m) passing through the corresponding intersection and having a gate electrode connected to the scanning signal line GL(n) passing through the corresponding intersection, and a pixel electrode connected to a drain electrode of the pixel TFT 101. A liquid crystal capacitance Clc is formed by the pixel electrode and the common electrode, and an auxiliary capacitance Ccs is formed by the pixel electrode and the auxiliary capacitance line CSL(n).

The display control circuit 500 receives display data DAT and a timing control signal TS from outside and outputs an analog image signal AV, a data start pulse signal SSP, a data clock signal SCK, a gate start pulse signal GSP, and a gate clock signal GCK as signals for displaying an image represented by the display data DAT on the display panel 190.

The data signal line drive circuit 200 receives the analog image signal AV, the data start pulse signal SSP and the data clock signal SCK, which are outputted from the display control circuit 500, and sequentially applies the analog image signal AV to the respective data signal lines DL, based on the data start pulse signal SSP and the data clock signal SCK. In this manner, driving is performed by a so-called dot sequential driving method. The present embodiment is not limited to the dot sequential driving method, but the driving may be performed by a so-call SSD (Source Shared Driving) method in which the plurality of data signal lines DL are divided into groups each made up of a predetermined number of data signal lines DL, and a predetermined number of data signals corresponding to each of the groups are subjected to time division by a common output buffer to the predetermined number of data signal lines DL to thereby drive each of the groups. In this case, the data signal line drive circuit 200 receives a digital image signal DV in place of the analog image signal AV, and serial/parallel-converts the digital image signal DV, and then, digital/analog-converts the same to generate the data signal.

The scanning signal line drive circuit 300 sequentially selects the plurality of scanning signal lines GL(1) to GL(N) every horizontal scanning period in each frame period (each vertical scanning period) for displaying an image on the display panel 190, and applies an active scanning signal (a voltage to put the pixel TFTs 101 included in the pixel circuits into a conductive state) to the selected scanning signal line.

The auxiliary capacitance line drive circuit 400 applies an auxiliary capacitance signal (a predetermined low potential VL or a predetermined high potential VH), which will be a bias of a voltage to be applied to the liquid crystal layer of the display panel 190, to the plurality of auxiliary capacitance lines CSL(1) to CSL(N) independently. The potential applied to the auxiliary capacitance lines are not limited to the two types, that is, the low potential VL and the high potential VH. That is, three or more types of potentials may be used.

To the common electrode formed commonly to the respective pixel circuits is supplied a common potential Vcom, which will be a reference of the voltage to be applied to the liquid crystal layer of the display panel 190, by a common electrode drive circuit not shown.

As described above, the plurality of data signals are applied to the plurality of data signal lines DL(1) to DL(M), respectively, and the plurality of scanning signals are applied to the plurality of scanning signal lines GL(1) to GL(N), respectively, by which in each of the pixel circuits in the display panel 190, a voltage in accordance with a pixel value of the pixel to be displayed is supplied through the pixel TFT 101 to the pixel electrode with the common potential Vcom as the reference to retain the same in the pixel capacitance made up of the liquid crystal capacitance Clc and the auxiliary capacitance Ccs in each of the pixel circuits. This allows the voltage equivalent to a potential difference between each of the pixel electrodes and the common electrode to be applied to the liquid crystal layer. The display panel 190 displays the image represented by the display data DAT by controlling light transmittance of the liquid crystal layer by the applied voltage.

<0.2 Operation of Conventional Liquid Crystal Display Device>

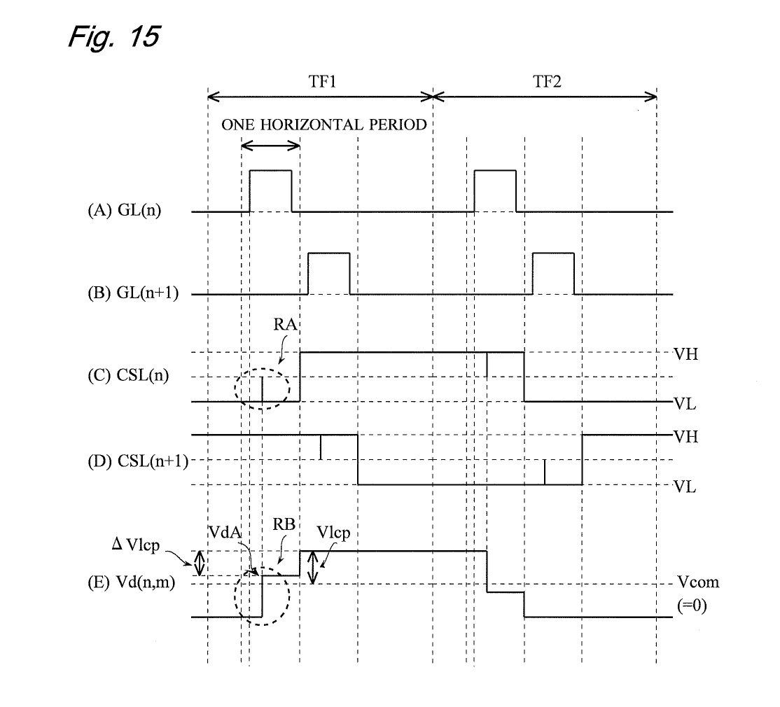

FIGS. 15A to 15E are diagrams respectively showing voltage waveforms of a potential of the scanning signal line GL(n), a potential of the scanning signal line GL(n+1), a potential of the auxiliary capacitance line CSL(n), a potential of the auxiliary capacitance line CSL(n+1) and a potential Vd(n, m) of the pixel electrode (hereinafter, referred to as a “pixel potential”) in a first frame period TF1 and a second frame period TF2, which are consecutive two frame periods. Here, a 1H reversal driving method is employed, in which polarity of the data signals to be applied to the data signal lines DL(1) to DL(M) with the common potential Vcom as the reference is reversed in each horizontal period for driving, and a case where the display is performed in a normally black mode is described as one example. While Vcom=0 is employed, the present embodiment is not limited thereto.

In the first frame period TF1, when the scanning signal line GL(n) enters a selected state (FIG. 15(A)), the pixel TFTs 101 inside the pixel circuits P(n, 1) to P(n, M) connected to the scanning signal line GL(n) enter a conductive state. In a writing period to the pixel circuit P(n, m), a positive potential VdA as the data signal is supplied from the data signal line DL(m) to the pixel electrode to charge the pixel capacitance. As a result, the pixel potential Vd(n, m) is retained as VdA (FIG. 15(E)). Subsequently, when the scanning signal line GL(n) enters a non-selected state, and the pixel TFTs 101 connected to the scanning signal line GL(n) enter a shut state, the electric charge accumulated in the pixel capacitances are retained as it is. In this period, the potential of the auxiliary capacitance line CSL(n) is the predetermined low potential VL. Thereafter, the potential of the auxiliary capacitance line CSL(n) changes to the predetermined high potential VH. Thereafter, in a period till the next frame, the above-mentioned high potential VH is supplied to the auxiliary capacitance line CSL(n) to add a bias voltage ΔVlcP to the pixel potential Vd(n, m). As a result, a voltage VlcP shown in FIG. 15(E) is applied to a portion of the liquid crystal layer sandwiched between the pixel electrode and the common electrode, and the electric charge is retained in a period till the pixel TFTs 101 again enter the conductive state. In the second frame period TF2, which is the next frame, operation similar to that in the first frame period TF1 is performed (however, the polarity is reversed). The above-described operation enables the large voltage to be applied to the liquid crystal layer with a small data signal amplitude, which can reduce power consumption.

<0.3 Review>

However, as described above, since the auxiliary capacitance Ccs is formed by the pixel electrode and the auxiliary capacitance line CSL(n), potential fluctuation of the pixel potential Vd(n, m) generated when the data signal is written to the pixel electrode is transmitted to the auxiliary capacitance line CSL(n) through the auxiliary capacitance Ccs. A potential fluctuation amount ΔV (hereinafter, referred to as a “potential fluctuation ΔV” as well) of the auxiliary capacitance line CSL(n) generated at this time is approximately represented by the following equation (1).

ΔV=Vdpre(n,m)−Vdat (1)

where Vdpre(n, m) represents a pixel potential defined by changing the potential of the auxiliary capacitance line CSL(n) after the selection period of the scanning signal line GL(n) has ended in the previous frame, and Vdat represents a voltage of the data signal to be written in the next frame.

As shown in FIG. 15(C), in the auxiliary capacitance line CSL(n), when the polarity of the pixel potential Vd(n, m) is changed from negative to positive, and when it is changed from positive to negative, the potential fluctuation ΔV is generated (indicated by a straight line in the figure). Similarly, as shown in FIG. 15(D), in the auxiliary capacitance line CSL(n+1) as well, when the polarity of a pixel potential Vd(n+1, m) changes (not shown), the potential fluctuation ΔV is generated (indicated by a straight line in the figure). While, for example, the auxiliary capacitance line CSL(n) is actually affected by potential fluctuations of the pixel potentials Vd(n, 1) to Vd(n, m−1) and Vd(n, m+1) to Vd(n, M), illustration and description thereof are omitted for convenience. Moreover, while when the selected state of the scanning signal line GL(n) puts the pixel TFTs 101 into the conductive state, the pixel potential Vd(n, m) also fluctuates due to influence of parasitic capacitances of the data signal lines DL(1) to DL(M), illustration and description thereof are omitted for convenience.

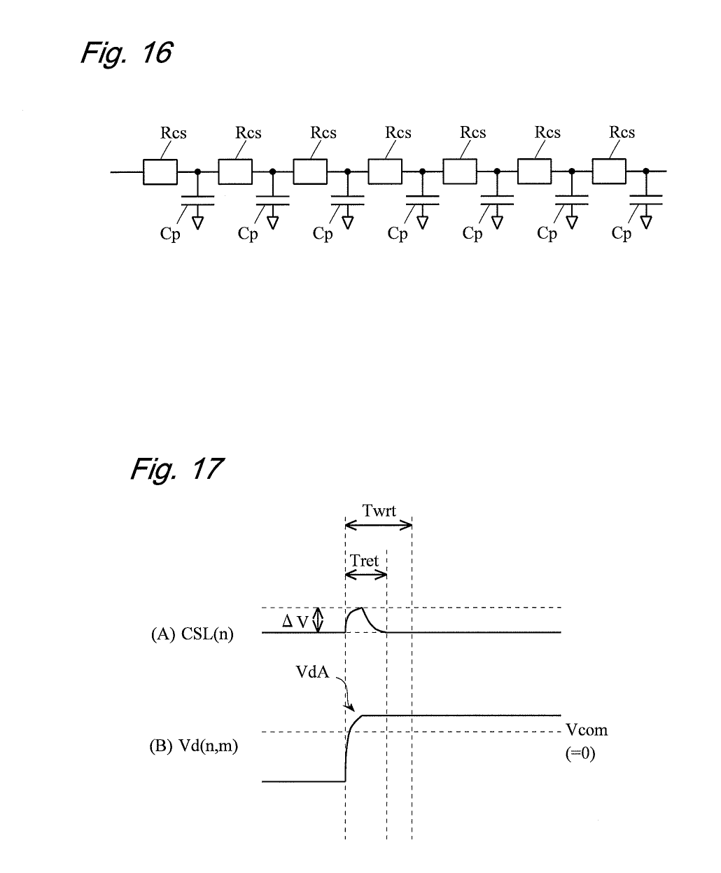

As shown in FIG. 16, the auxiliary capacitance line CSL(n) can be represented by an equivalent circuit made up of wiring resistances Rcs and parasitic capacitances Cp. The auxiliary capacitance line CSL(n) in which the potential fluctuation ΔV is generated tries to return to an initial potential by charging/discharging the electric charge retained in the parasitic capacitances Cp. In the present specification, time from a time point when the potential fluctuation ΔV is generated in the auxiliary capacitance line CSL(n) to a time point when a potential difference between the potential of the auxiliary capacitance line CSL(n) in which the potential fluctuation ΔV is generated and the above-described initial potential becomes a predetermined minute potential difference Δε(≈0 V) is referred to as “return time Tret”. The return time Tret depends on a resistance value of wiring resistances Rcs, a capacitance value of the parasitic capacitances Cp and the potential fluctuation amount ΔV. That is, if the potential fluctuation amount ΔV is considered to be constant, the larger a time constant defined by the resistance value of the wiring resistances Rcs and the capacitance value of the parasitic capacitances Cp is, the longer the return time Tret is. As described above, since a selection switch is required in the auxiliary capacitance line drive circuit 400 for switching over the potential of the auxiliary capacitance line CSL(n) between the low potential VL and the high potential VH, an impedance of the auxiliary capacitance line CSL(n) when viewed from the auxiliary capacitance line drive circuit 400 further rises. Thus, particularly, in the method in which the reverse polarity driving is performed by changing the potential of the corresponding auxiliary capacitance line after the selection period of each of the scanning signal lines has ended, the time constant is larger, and the return time Tret is longer.

FIGS. 17(A) and 17(B) are voltage waveform diagrams of the potential of the auxiliary capacitance line CSL(n) resulting from enlarging a portion RA surrounded by a dashed line in FIG. 15(C), and the pixel potential Vd(n, m) resulting from enlarging a portion RB surrounded by a dashed line in FIG. 15(E), respectively, when Twrt>Tret is satisfied, where Twrt represents a writing period of the pixel potential Vd(n, m). In waveforms shown in FIGS. 17(A) and 17(B), the potential of the auxiliary capacitance line CSL(n) returns within the writing period Twrt of the pixel potential Vd(n, m). In this case, the pixel potential Vd(n, m) is not affected by the potential fluctuation of the auxiliary capacitance line CSL(n).

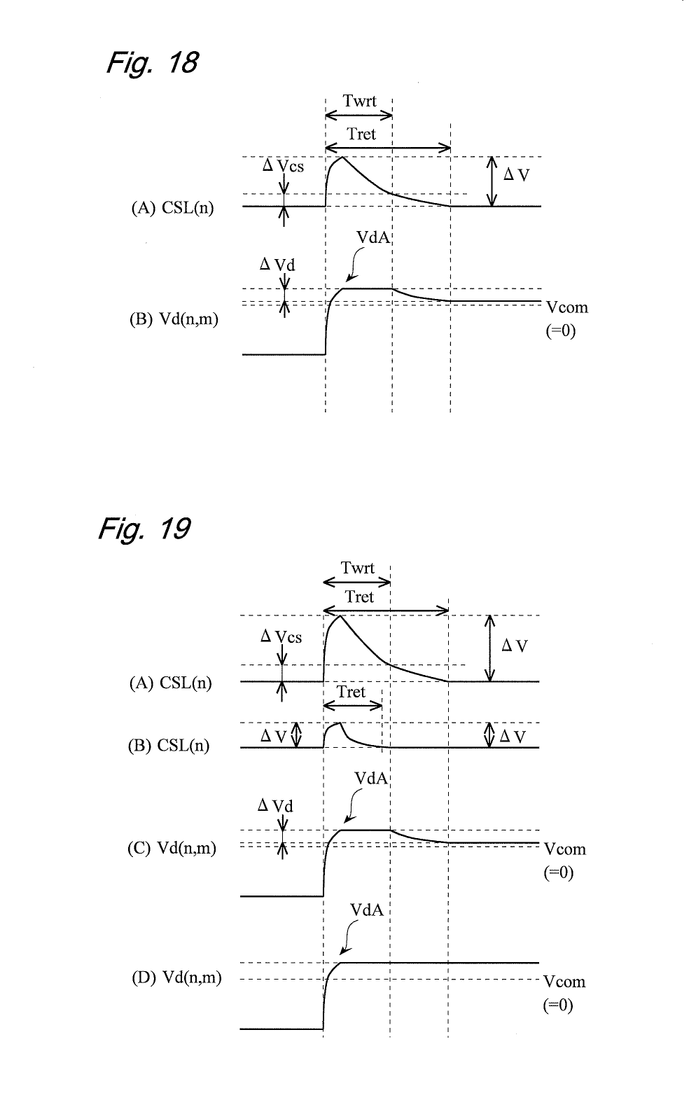

FIGS. 18(A) and 18(B) are voltage waveform diagrams of the potential of the auxiliary capacitance line CSL(n) resulting from enlarging the portion RA surrounded by the dashed line in FIG. 15(C), and the pixel potential Vd(n, m) resulting from enlarging the portion RB surrounded by the dashed line in FIG. 15(E), respectively, when Twrt<Tret is satisfied. The waveforms shown in FIGS. 18(A) and 18(B), the potential of the auxiliary capacitance line CSL(n) does not return within the writing period Twrt of the pixel potential Vd(n, m). In this case, the pixel potential Vd(n, m) fluctuates by a fluctuation amount ΔVd proportional to a remainder voltage ΔVcs, which is a difference between the potential of the auxiliary capacitance line CSL(n) at a time point when the writing period Twrt ends, and the original potential of the auxiliary capacitance line CSL(n) (ΔVd<ΔVcs). That is, the pixel potential Vd(n, m) becomes (VdA−ΔVd), so that it has a different value from that of the potential VdA to be originally retained. This causes horizontal crosstalk.

Moreover, if the resistance value of the wiring resistances Rcs and the capacitance value of the parasitic capacitances Cp are considered to be constant, whether or not the pixel potential Vd(n, m) is affected is decided by a magnitude of the potential fluctuation amount ΔV of the auxiliary capacitance line CSL(n). FIGS. 19(A) and 19(C) are voltage waveform diagrams resulting from enlarging the portions RA and RB surrounded by the dashed lines in FIG. 15, respectively (when the potential fluctuation amount ΔV is large). On the other hand, FIGS. 19(B) and 19(D) are voltage waveform diagrams resulting from enlarging the portions RA and RB surrounded by the dashed lines in FIG. 15, respectively (when the potential fluctuation amount ΔV is small). Since when the potential fluctuation amount ΔV is small, Twrt>Tret is satisfied, the pixel potential Vd(n, m) is hardly affected by the potential fluctuation amount ΔV (FIGS. 19(B), 19(D)). On the other hand, since when the potential fluctuation amount ΔV is large, Twrt<Tret is satisfied, the remainder voltage ΔVcs is generated, so that the pixel potential Vd(n, m) has a different value from that of the potential VdA to be originally retained. This causes horizontal crosstalk, as described above.

The above-described influence exerted by the remainder voltage ΔVcs on the pixel potential Vd(n, m) becomes remarkable, particularly, in a display pattern made of a gray background portion and a white central portion as shown in FIG. 20. In FIG. 20, the gray background portion is represented by hatching of thin lines, and a blackish portion described later is represented by hatching of thick lines. Moreover, in FIG. 20, for convenience of description, a size of the respective pixels is not uniform. Furthermore, a downward arrow and a rightward arrow in FIG. 20 indicate a vertical scanning direction and a horizontal scanning direction in image display, respectively. The pixels corresponding to the scanning signal line GL(n) and the auxiliary capacitance line CSL(n) are all gray, and display unevenness is not caused. On the other hand, the pixels corresponding to the scanning signal line GL(p) and the auxiliary capacitance line CSL(p) are gray or white, and although the pixel corresponding to the data signal line DL(m+2) should be gray, the occurrence of the horizontal crosstalk makes it blackish. Here, referring to FIGS. 20, 21(A) to 21(D), and 22(A) to 22(D), the horizontal crosstalk will be further described.

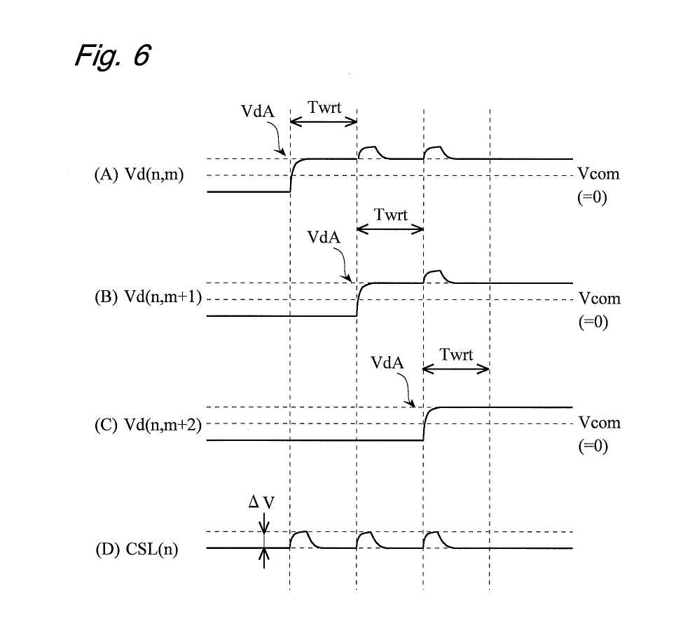

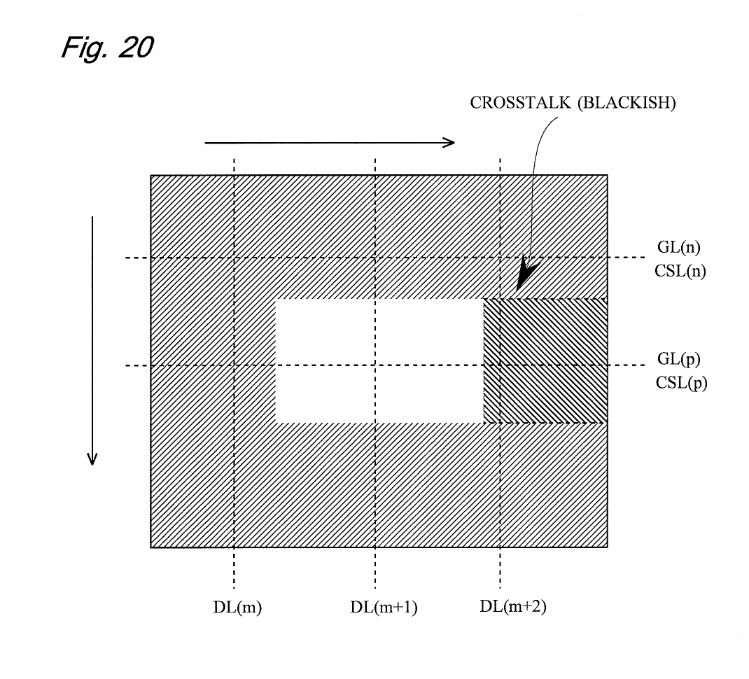

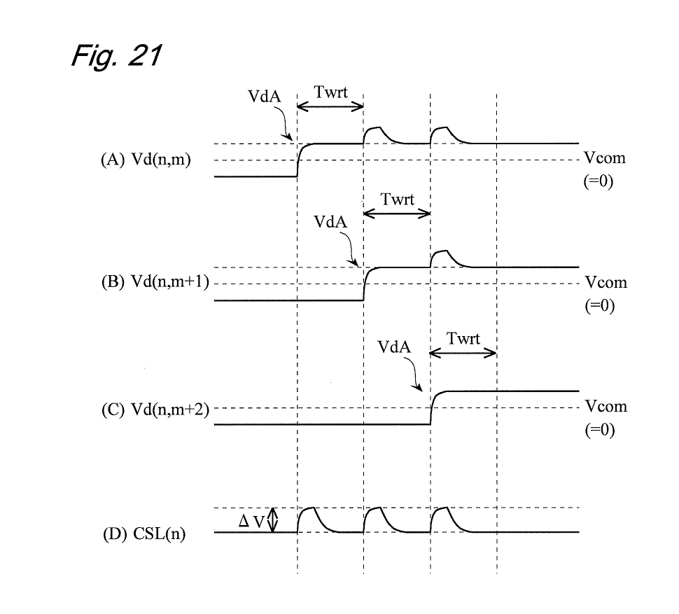

FIGS. 21(A) to 21(D) are voltage waveform diagrams of pixel potentials Vd(n, m) to Vd(n, m+2) and the potential of the auxiliary capacitance line CSL(n) in FIG. 20, respectively. In the pixel potentials Vd(n, m) to Vd(n, m+2) shown in FIGS. 21(A) to 21(C), respectively, the influence by the potential fluctuation ΔV in the auxiliary capacitance line CSL(n) before each of the writing periods Twrt is omitted for convenience (similar in FIGS. 6(A) to 6(C) described later). In the potential of the auxiliary capacitance line CSL(n) shown in FIG. 21(D), the influence by the pixel potentials Vd(n, 1) to Vd(n, m−1), and Vd(n, m+3) to Vd(n, M) is omitted for convenience (similar in FIG. 6(D) described later). Since the pixels corresponding to the pixel potentials Vd(n, m) to Vd(n, m+2) are all gray, the writing potentials corresponding to the pixel potentials Vd(n, m) to Vd(n, m+2) are all VdA. Thus, the potential fluctuation amount ΔV in the auxiliary capacitance line CSL(n) generated at the writing time of each of the pixel potentials is uniform. Therefore, in the pixels corresponding to the scanning signal line GL(n) and the auxiliary capacitance line CSL(n), the horizontal crosstalk is not caused.

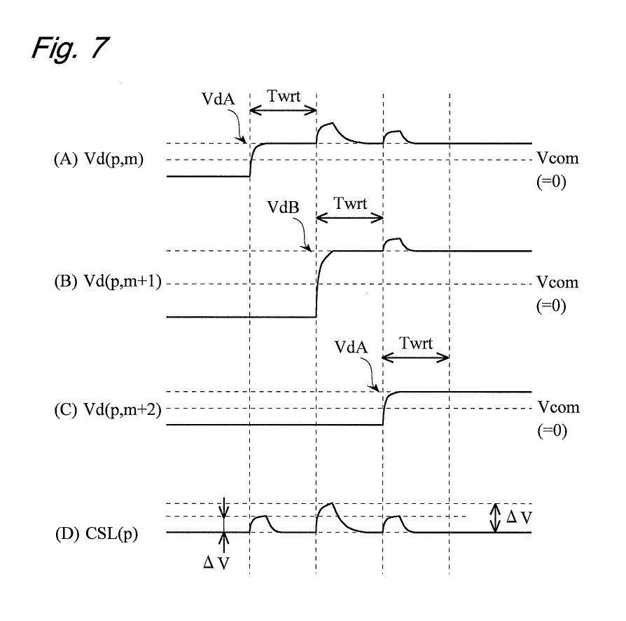

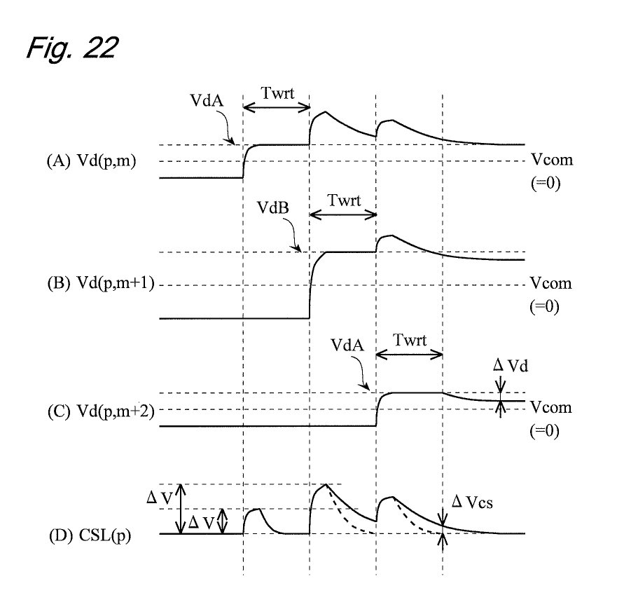

FIGS. 22(A) to 22(D) are voltage waveform diagrams of pixel potentials Vd(p, m) to Vd(p, m+2) and a potential of an auxiliary capacitance line CSL(p) in FIG. 20, respectively. In the pixel potentials Vd(p, m) to Vd(p, m+2) shown in FIGS. 22(A) to 22(C), respectively, the influence by the potential fluctuation ΔV in the auxiliary capacitance line CSL(p) before each of the writing periods Twrt is omitted for convenience (similar in FIGS. 7(A) to 7(C) described later). Moreover, in the potential of the auxiliary capacitance line CSL(p) shown in FIG. 22(D), the influence by pixel potentials Vd(p, 1) to Vd(p, m−1), and Vd(p, m+3) to Vd(p, M) is omitted for convenience (similar in FIG. 7(D) described later). The pixels corresponding to the pixel potentials Vd(p, m) and Vd(p, m+2) are gray, and the pixel corresponding to the pixel potential Vd(p, m+1) is white. The writing potentials corresponding to the pixel potentials Vd(p, m) and Vd(p, m+2) are VdA, and the writing potential corresponding to the pixel potential Vd(p, m+1) is VdB (>VdA). Therefore, the potential fluctuation amount ΔV in the auxiliary capacitance line CSL(p) generated at the writing time of the pixel potentials Vd(p, m) and Vd(p, m+2) are small, and the potential fluctuation amount ΔV in the auxiliary capacitance line CSL(p) generated at the writing time of the pixel potential Vd(p, m+1) is large. If the potential of the auxiliary capacitance potential CSL(p), which largely fluctuates at the writing time of the pixel potential Vd(p, m+1), does not return to the original potential before the writing end of the pixel potential Vd(p, m+2), deviation is caused in the potential of the auxiliary capacitance line CSL(p) at the writing start time of the pixel potential Vd(p, m+2) (in the figures, solid lines each indicate the deviated potential, and dashed lines each indicate an ideal potential). Due to influence of the above-described deviation of the potential of the auxiliary capacitance line CSL(p), the potential of the auxiliary capacitance line CSL(p) does not return to the original potential within the writing period of the pixel potential Vd(p, m+2), and the remainder voltage ΔVcs is generated. As a result, the pixel potential Vd(p, m+2) becomes (VdA−ΔVd), and has a different value from that of the potential VdA to be originally retained, so that the corresponding pixel becomes more blackish than gray to be originally displayed. The pixel potential Vd(p, m+1) corresponding to white display also has a different value from that of the potential VdB to be originally retained, so that it becomes more blackish than the original.

When the configuration of the liquid crystal display device described in Patent Document 4 is employed in order to dissolve the horizontal crosstalk described above, the respective auxiliary capacitance lines cannot be driven independently, as described above. Thus, the above-described configuration cannot be employed for the liquid crystal display device using the method of changing the potential of the corresponding auxiliary capacitance line after the selection period of each of the scanning signal lines has ended to thereby perform the reverse polarity driving.

Moreover, in the case where the configuration of the liquid crystal display device described in Patent Document 5 is employed, similarly, the respective auxiliary capacitance lines cannot be driven independently, as described above. Thus, similarly, the above-described configuration cannot be employed for the liquid crystal display device using the method of changing the potential of the corresponding auxiliary capacitance line after the selection period of each of the scanning signal lines has ended to thereby perform the reverse polarity driving, either.

Embodiments of the present invention devised by the inventor of the present application will be described below with reference to the accompanying drawings, based on the foregoing basic consideration.

### 1. First Embodiment

### 1.1 Configuration of Liquid Crystal Display Device

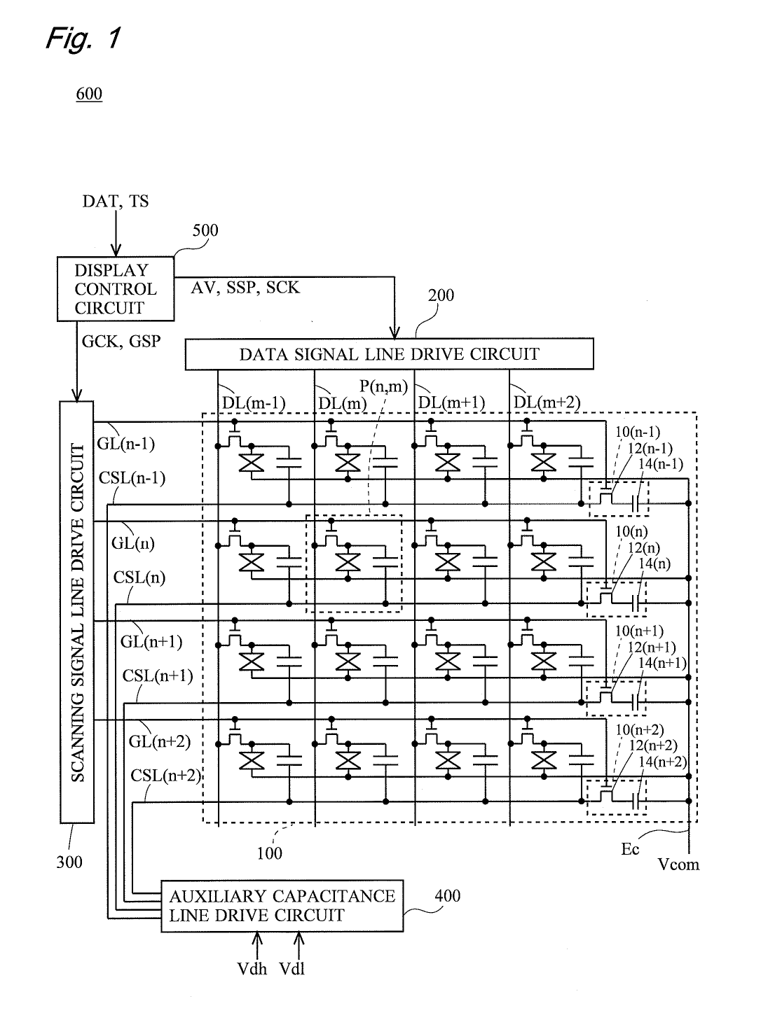

FIG. 1 is a circuit diagram showing an electric configuration of a liquid crystal display device 600 according to a first embodiment of the present invention. Of components of the present embodiment, the same components as those of the conventional liquid crystal display device 690 are denoted by the same reference characters, and descriptions thereof are omitted. As shown in FIG. 1, the liquid crystal display device 600 according to the present embodiment includes a display panel 100, a data signal line drive circuit 200, a scanning signal line drive circuit 300, an auxiliary capacitance line drive circuit 400, and a display control circuit 500. Any or all of the data signal line drive circuit 200, the scanning signal line drive circuit 300, the auxiliary capacitance line drive circuit 400 and the display control circuit 500 are mounted, for example, on a TFT substrate of the display panel 100 as an IC (Integrated Circuit). Moreover, any or all of the data signal line drive circuit 200, the scanning signal line drive circuit 300 and the auxiliary capacitance line drive circuit 400 may be formed integrally with the display panel 100.

The scanning signal line drive circuit 300 receives a gate start pulse signal GSP and a gate clock signal GCK from the display control circuit 500, and sequentially selects a plurality of scanning signal lines GL(1) to GL(N) every horizontal scanning period in each frame period (each vertical scanning period) for displaying a display image on the display panel 100, and applies an active scanning signal (a voltage to put pixel TFTs 101 included in pixel circuits into a conductive state) to the selected scanning signal line. In the present embodiment and respective embodiments described later, the scanning is performed in ascending order of numbers assigned to the scanning signal lines GL. That is, the scanning signal lines are selected in an order of GL(1)->GL(2)-> . . . ->GL(N). Hereinafter, this scanning direction is referred to as a “first direction”. Moreover, hereinafter, a scanning direction in which the scanning signal lines are selected in an order of GL(N)->GL(N−1)-> . . . ->GL(1) is referred to as a “second direction”. In the present embodiment and the respective embodiments described later, as the scanning direction, either of the first direction or the second direction may be employed.

To a common electrode Ec formed commonly to the respective pixel circuits is supplied a common potential Vcom (a fixed potential), which will be a reference of a voltage to be applied to a liquid crystal layer of the display panel 100, by a common electrode drive circuit not shown.

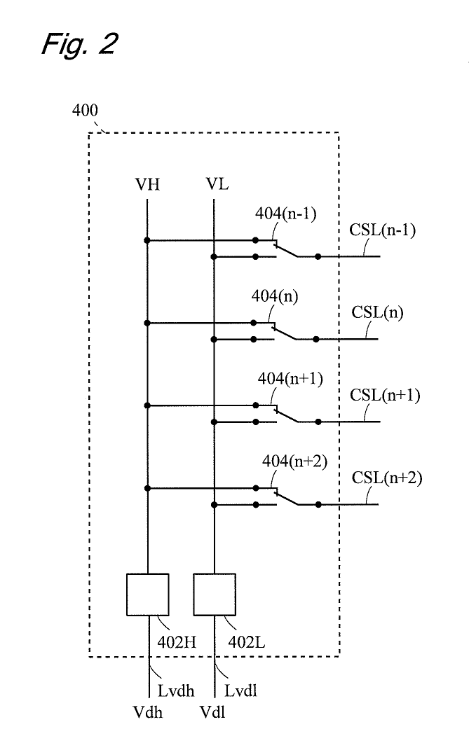

The auxiliary capacitance line drive circuit 400 independently applies, to a plurality of auxiliary capacitance lines CSL(1) to CSL(N), an auxiliary capacitance signal which will be a bias of the voltage to be applied to the liquid crystal layer of the display panel 100 (a predetermined low potential VL or a predetermined high potential VH). Particularly, the auxiliary capacitance line drive circuit 400, as shown in FIG. 2, includes a low potential supply part 402L and a high potential supply part 402H that receive an L-side power supply potential Vdl supplied from an L-side power supply line Lvdl, and an H-side power supply potential Vdh supplied from an H-side power supply line Lvdh, respectively, and potential switches 404(1) to 404(N) that switch over a potential to be applied to the auxiliary capacitance lines CSL(1) to CSL(N) between the low potential VL and the high potential VH, respectively.

The low potential supply part 402L generates the low potential VL, based on the received L-side power supply potential Vdl. The high potential supply part 402H generates the high potential VH, based on the received H-side power supply potential Vdh. The low potential VL and the high potential VH generated by the low potential supply part 402L and the high potential supply part 402H, respectively, are supplied to the potential switches 404(1) to 404(N). The potential switches 404(1) to 404(N) switch over the potential to be applied to the auxiliary capacitance lines CSL(1) to CSL(N) between the low potential VL and the high potential VH, respectively, as described above.

### 1.2 Configuration of Display Panel

The display panel 100 is obtained by adding smoothing parts 10(1) to 10(N) (hereinafter, referred to as a “smoothing part(s) 10” when these are not distinguished) to the display panel 190 included in the conventional liquid crystal display device 690, the smoothing parts 10(1) to 10(N) being provided, corresponding to the scanning signal lines GL(1) to GL(N), respectively. The smoothing parts 10 are provided on an output end side of the auxiliary capacitance lines CSL (in FIG. 1, on the right side in the display panel 100). The auxiliary capacitance lines CSL arranged along the corresponding scanning signal lines GL and the common electrode Ec are connected to one another through the smoothing parts 10. For example, through the smoothing part 10(n), the auxiliary capacitance line CSL(n) arranged along the scanning signal line GL(n) and the common electrode Ec are connected to each other.

The smoothing parts 10(1) to 10(N) have correction TFTs 12(1) to 12(N) (hereinafter, referred to as a “correction TFT(s) 12” when these are not distinguished) as second switching elements, respectively, and capacitors 14(1) to 14(N) (hereinafter, referred to a “capacitor(s) 14” when these are not distinguished) as capacitive elements, respectively. A source electrode as one of conduction terminals of the correction TFT 12 in the smoothing part 10, and the auxiliary capacitance line CSL arranged along the scanning signal line GL corresponding to the smoothing part 10 are connected to each other, and a drain electrode as the other of the conduction terminals of the correction TFT 12 in the smoothing part 10 and the common electrode Ec are connected to each other through the capacitor 14 in the smoothing part 10. For example, a source electrode of the correction TFT 12(n) and the auxiliary capacitance line CSL(n) arranged along the scanning signal line GL(n) are connected to each other, and a drain electrode of the correction TFT 12(n) and the common electrode Ec are connected to each other through the capacitor 14(n). Although the source electrode and the drain electrode of the corresponding correction TFT 12 are swapped depending on a potential of each of the auxiliary capacitance lines CSL, in the following description, the terminal on the side that is connected (or connected through the capacitor 14 as will be described later) to the auxiliary capacitance line CSL arranged along the scanning signal line GL to which a gate electrode of the correction TFT 12 is connected is the source electrode, and the terminal on the opposite side is the drain electrode.

The gate electrode of the correction TFT 12 in each of the smoothing parts 10 as a control terminal is connected to the scanning signal line GL corresponding to the smoothing part 10. For example, the gate electrode of the correction TFT 12(n) in the smoothing part 10(n) is connected to the scanning signal line GL(n). The correction TFT 12(n) is controlled so as to enter a conductive state when the scanning signal line GL(n) is in a selected state, and enter a shut state when the scanning signal line GL(n) is in a non-selected state.

### 1.3 Operation

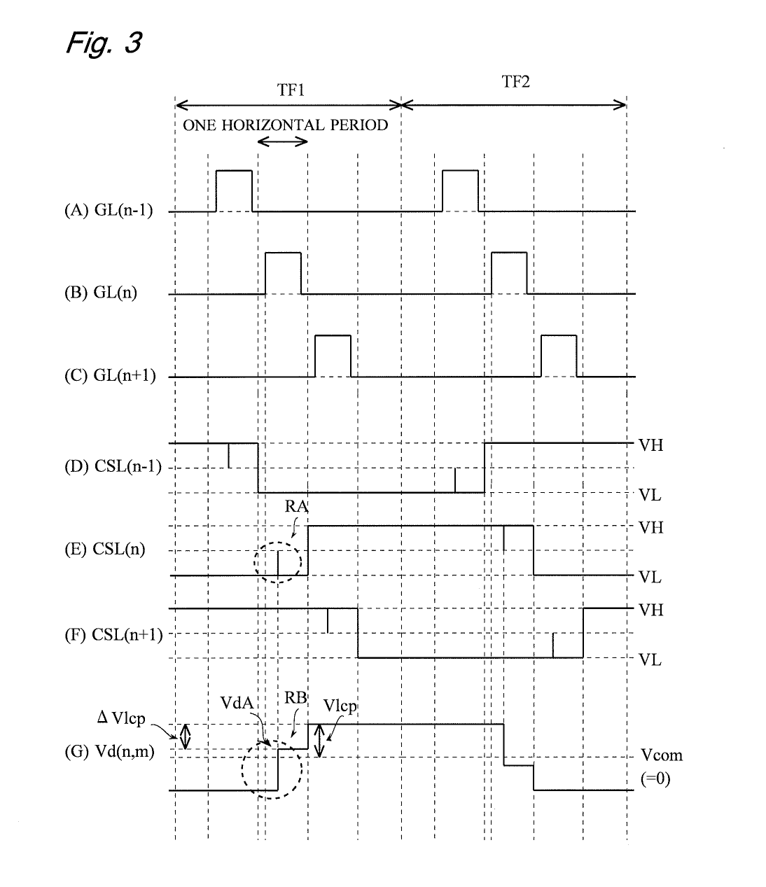

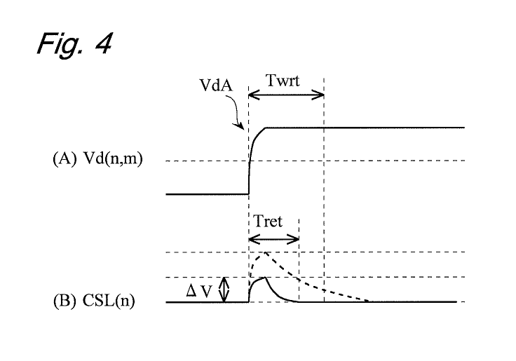

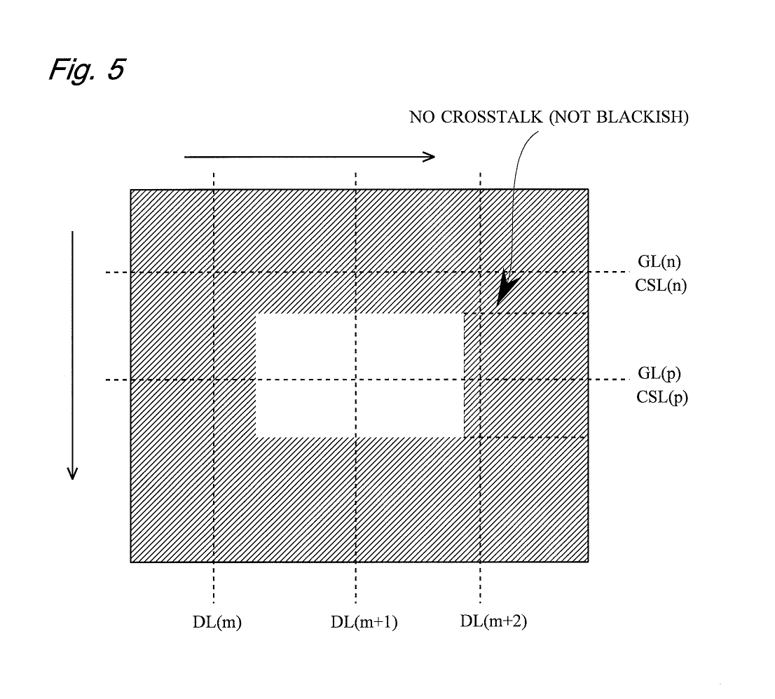

Referring to FIGS. 3(A) to 3(G), and FIGS. 4(A) and 4(B), operation of the liquid crystal display device 600 according to the present embodiment will be described.

FIGS. 3(A) to 3(G) are voltage waveform diagrams of a potential of the scanning signal line GL(n−1), a potential of the scanning signal line GL(n), a potential of the scanning signal line GL(n+1), a potential of the auxiliary capacitance line CSL(n−1), a potential of the auxiliary capacitance line CSL(n), a potential of the auxiliary capacitance line CSL(n+1), and a pixel potential Vd(n, m) in the first frame period TF1 and the second frame period TF2, which are consecutive two frame periods, respectively. Here, in the present embodiment, as in the conventional liquid crystal display device, a 1H reversal driving method is employed, in which polarity of data signals to be applied to data signal lines DL(1) to DL(M) with the counter electrode potential Vcom as the reference is reversed in each horizontal period for driving, and a case where the display is performed in a normally black mode is described as one example. While Vcom=0 is employed, the present embodiment is not limited thereto.

FIGS. 4(A) and 4(B) are voltage waveform diagrams of the pixel potential Vd(n, m) resulting from enlarging a portion RB surrounded by a dashed line in FIG. 3(G), and the potential of the auxiliary capacitance line CSL(n) resulting from enlarging a portion RA surrounded by a dashed line in FIG. 3(E) in the present embodiment. A waveform indicated by a dashed line in FIG. 4(B) shows the potential of the auxiliary capacitance line CSL(n) in the conventional liquid crystal display device.

In a first frame period TF1, when the scanning signal line GL(n) enters a selected state (FIG. 3(B)), the pixel TFTs 101 in pixel circuits P(n, 1) to P(n, M) connected to the scanning signal line GL(n) are put into the conductive state. At this time, the correction TFT 12(n) enters a conductive state. Putting the correction TFT 12(n) into the conductive state allows the auxiliary capacitance line CSL(n) arranged along the scanning signal line GL(n) in the selected state and the capacitor 14(n) to be electrically connected to each other. That is, the auxiliary capacitance line CSL(n) and the common electrode Ec to which the common potential Vcom as the fixed potential is supplied are electrically connected to each other through the capacitor 14(n).

In a writing period to the pixel circuit P(n, m), a positive potential VdA as the data signal from the data signal line DL(m) is supplied to a pixel electrode to charge a pixel capacitance. As described in the foregoing basic consideration, since potential fluctuation of the pixel potential Vd(n, m) generated when the data signal is written to the pixel electrode is transmitted to the auxiliary capacitance line CSL(n) through the auxiliary capacitance Ccs, a potential fluctuation ΔV is generated in the auxiliary capacitance line CSL(n) (the portion RA surrounded in the dashed line in FIG. 3(E)). As shown in FIGS. 3(D) to 3(F), respectively, in the auxiliary capacitance lines CSL(n−1) to CSL(n+1), the potential fluctuation ΔV is generated when polarity of the pixel potential Vd(n, m) is changed (in the figure, indicated by a straight line). For example, while the auxiliary capacitance line CSL(n) is actually affected by the potential fluctuation of the pixel potentials Vd(n, 1) to Vd(n, m−1) and Vd(n, m+1) to Vd(n, M), illustration and description thereof are omitted for convenience. Moreover, while when the selected state of the scanning signal line GL(n) puts the pixel TFTs 101 into the conductive state, the pixel potential Vd(n, m) fluctuates due to influence of the parasitic capacitance of each of the data signal lines DL(1) to DL(M), illustration and description thereof are omitted for convenience.

In the present embodiment, when the scanning signal line GL(n) is in the selected state, a high frequency component (corresponding to the potential fluctuation) of the auxiliary capacitance signal applied to the auxiliary capacitance line CSL(n) is supplied to the common electrode Ec through the capacitor 14(n), which reduces a magnitude of the potential fluctuation ΔV as compared with the conventional device. Accordingly, if the potential fluctuation ΔV is generated at the writing time of the data signal, in the conventional liquid crystal display device, the potential of the auxiliary capacitance line CSL(n) does not return within a writing period Twrt of the data signal (FIG. 4(B)), while in the present embodiment, the magnitude of the potential fluctuation ΔV is reduced as compared with the conventional device, so that the potential of the auxiliary capacitance line CSL(n) returns within the writing period Twrt (FIG. 4(B)). That is, return time Tret is shorter than that of the conventional device. As a result, since a remainder voltage ΔVcs, which is a difference between the potential of the auxiliary capacitance line CSL(n) at a time point of the writing period Twrt ends, and the original potential of the auxiliary capacitance line CSL(n) is not generated, the potential VdA to be originally retained is retained in the pixel potential Vd(n, m) (FIGS. 3(G), 4(A)). The common potential Vcom to be applied to the common electrode Ec only needs to be the fixed potential when each of the scanning signal lines GL is in a selected state. For example, the common potential Vcom may fluctuate between a period when the scanning signal line GL(n) is in a selected state, and a period when a scanning signal line GL(n+1) is in a selected state.

Subsequently, when the scanning signal line GL(n) enters a non-selected state, and the pixel TFTs 101 connected to the scanning signal line GL(n) enter a shut state, the electric charge accumulated in the pixel capacitances are retained as it is. In this period, the potential of the auxiliary capacitance line CSL(n) is the low potential VL. Thereafter, the potential of the auxiliary capacitance line CSL(n) changes to the high potential VH. Moreover, when the scanning signal line GL(n) is in the non-selected state, the correction TFT 12(n) is in a shut state. That is, when the scanning signal line GL(n) is in the non-selected state, the auxiliary capacitance line CSL(n) and the capacitor 14(n) are in an electrically disconnected state. Accordingly, the change from the low potential VL to the high potential VH in the auxiliary capacitance line CSL(n) does not affect the common electrode Ec through the capacitor 14(n), and the change from the low potential VL to the high potential VH is not delayed by the influence of the capacitor 14(n).

Thereafter, in a period till the next frame, the high potential VH is supplied to the auxiliary capacitance line CSL(n) to add a bias voltage ΔVlcP to the pixel potential Vd(n, m). As a result, a voltage VlcP shown in FIG. 3(G) is applied to a portion of the liquid crystal layer sandwiched between the pixel electrode and the common electrode, and the electric charge is retained in a period until the pixel TFTs 101 again enter the conductive state. The above-described operation enables the large voltage to be applied to the liquid crystal layer with a small data signal amplitude, which can reduce power consumption. In a second frame period TF2, which is the next frame, operation similar to that in the first frame period TF1 is performed (however, the polarity is reversed). The above-described operation enables the large voltage to be applied to the liquid crystal layer with a small data signal amplitude, which can reduce power consumption.

Here, referring to FIGS. 5 to 7, how the horizontal crosstalk is suppressed in the present embodiment will be described. FIG. 5 is a diagram showing a display pattern in the present embodiment, which is similar to the display pattern made of the gray background portion and the white central portion shown in FIG. 20. In FIG. 5, a gray background portion is represented by hatching. Moreover, in FIG. 5, for convenience of description, a size of the respective pixels is not uniform. Furthermore, a downward arrow and a rightward arrow in FIG. 5 indicate a vertical scanning direction and a horizontal scanning direction in image display, respectively.

FIGS. 6(A) to 6(D) are voltage waveform diagrams of the pixel potentials Vd(n, m) to Vd(n, m+2) and the potential of the auxiliary capacitance line CSL(n) in FIG. 5, respectively. Since the pixels corresponding to the pixel potentials Vd(n, m) to Vd(n, m+2) are all gray, writing potentials corresponding to the pixel potentials Vd(n, m) to Vd(n, m+2) are all VdA. Thus, a potential fluctuation amount in the auxiliary capacitance line CSL(n) generated at the writing time of each of the pixel potentials is uniform. Therefore, in the pixels corresponding to the scanning signal line GL(n) and the auxiliary capacitance line CSL(n), the horizontal crosstalk is not caused. In this manner, in the case where the pixels in the same color (gray) are consecutive, the display is similar to that of the conventional liquid crystal display device. Since the high frequency component (corresponding to the potential fluctuation) of the auxiliary capacitance signal applied to the auxiliary capacitance line CSL(n) when the scanning signal line GL(n) is in the selected state is supplied to the common electrode Ec through the capacitor 14(n), the potential fluctuation amount ΔV in the auxiliary capacitance line CSL(n) is made smaller than that of the conventional device even when the pixels in the same color (gray) are consecutive.

FIGS. 7(A) to 7(D) are voltage waveform diagrams of the pixel potentials Vd(p, m) to Vd(p, m+2), and the potential of the auxiliary capacitance line CSL(p) in FIG. 5, respectively. The pixels corresponding to the pixel potentials Vd(p, m) and Vd(p, m+2) are gray, and the pixel corresponding to the pixel potential Vd(p, m+1) is white. The writing potentials corresponding to the pixel potentials Vd(p, m) and Vd(p, m+2) are VdA, and the writing potential corresponding to the pixel potential Vd(p, m+1) is VdB (>VdA). Therefore, the potential fluctuation amount ΔV in the auxiliary capacitance line CSL(p) generated at the writing time of the pixel potentials Vd(p, m) and Vd(p, m+2) is small, and the potential fluctuation amount ΔV in the auxiliary capacitance line CSL(p) generated at the writing time of the pixel potential Vd(p, m+1) is large. However, in the present embodiment, since the high frequency component (corresponding to the potential fluctuation) of the auxiliary capacitance signal applied to the auxiliary capacitance line CSL(p) when the scanning signal line GL(p) is in the selected state is supplied to the common electrode Ec through the capacitor 14(p), the potential fluctuation amount ΔV generated in the auxiliary capacitance line CSL(p) is smaller than that of the conventional device at the writing time of any of the pixel potentials Vd(p, m) to Vd(p, m+2). Accordingly, unlike the conventional liquid crystal display device 690, even if the potential of the auxiliary capacitance line CSL(p) fluctuates at the writing time of the pixel potential Vd(p, m+1), the fluctuation amount is smaller than that of the conventional device, and thus, the fluctuating potential returns to the original potential before the writing of the pixel potential Vd(p, m+2), and a deviation in the potential of the auxiliary capacitance line CSL(p) at the writing start time of the pixel potential Vd(p, m+2) is not caused. Since thereby, the potential fluctuation ΔV of the auxiliary capacitance line CSL(p) generated at the writing time of the pixel potential Vd(p, m+2) is also dissolved in the writing time, the remainder voltage AVcs is not generated. As a result, since the pixel potential Vd(p, m+2) is retained as VdA, which is the original writing potential, the pixel corresponding to the pixel potential Vd(p, m+2) is not blackish but gray, which is the same as a color to be originally displayed. In this manner, in the display pattern displayed in the liquid crystal display device 600 according to the present embodiment, the horizontal crosstalk is not caused, which is different from the display pattern displayed in the conventional liquid crystal display device.

### 1.4 Effects

According to the present embodiment, when the scanning signal line GL(n) is in the selected state, the common electrode Ec to which the common potential Vcom as the fixed potential is supplied, and the auxiliary capacitance line CSL(n) are electrically connected through the capacitor 14(n). Since this makes the potential fluctuation amount ΔV of the auxiliary capacitance line CSL(n) generated at the writing time of the data signal smaller than that of the conventional device, the time Tret till the potential of the auxiliary capacitance line CSL(n) returns to the original potential becomes shorter than that of the conventional device. This prevents the fluctuation of the pixel potential Vd(n, m) attributed to the potential fluctuation of the auxiliary capacitance line CSL(n) from being caused. Moreover, since the potential of the auxiliary capacitance line CSL(n) changes after the scanning signal line GL(n) is switched from the selected state to the non-selected state, by which the bias voltage is applied to the pixel potential, so that the large voltage can be applied to the liquid crystal layer with a small data signal amplitude. Accordingly, the horizontal crosstalk can be suppressed while reducing the power consumption.

Moreover, according to the present embodiment, when the scanning signal line GL(n) is in the selected state, the auxiliary capacitance line CSL(n) and the capacitor 14(n) are in an electrically-connected state, and when the scanning signal line GL(n) is in the non-selected state, the auxiliary capacitance line CSL(n) and the capacitor 14(n) are in an electrically disconnected state. Thus, the change from the low potential VL to the high potential VH in the auxiliary capacitance line CSL(n) does not affect the common electrode Ec through the capacitor 14(n), and the change is not delayed by the influence of the capacitor 14(n). This can suppress the horizontal crosstalk while suppressing deterioration in display quality attributed to other than the horizontal crosstalk.

Moreover, provision of the correction TFTs 12 and the capacitors 14 corresponding to the respective scanning signal lines GL is sufficient in order to realize the present embodiment. Thus, it is possible to realize the present embodiment with a simple configuration.

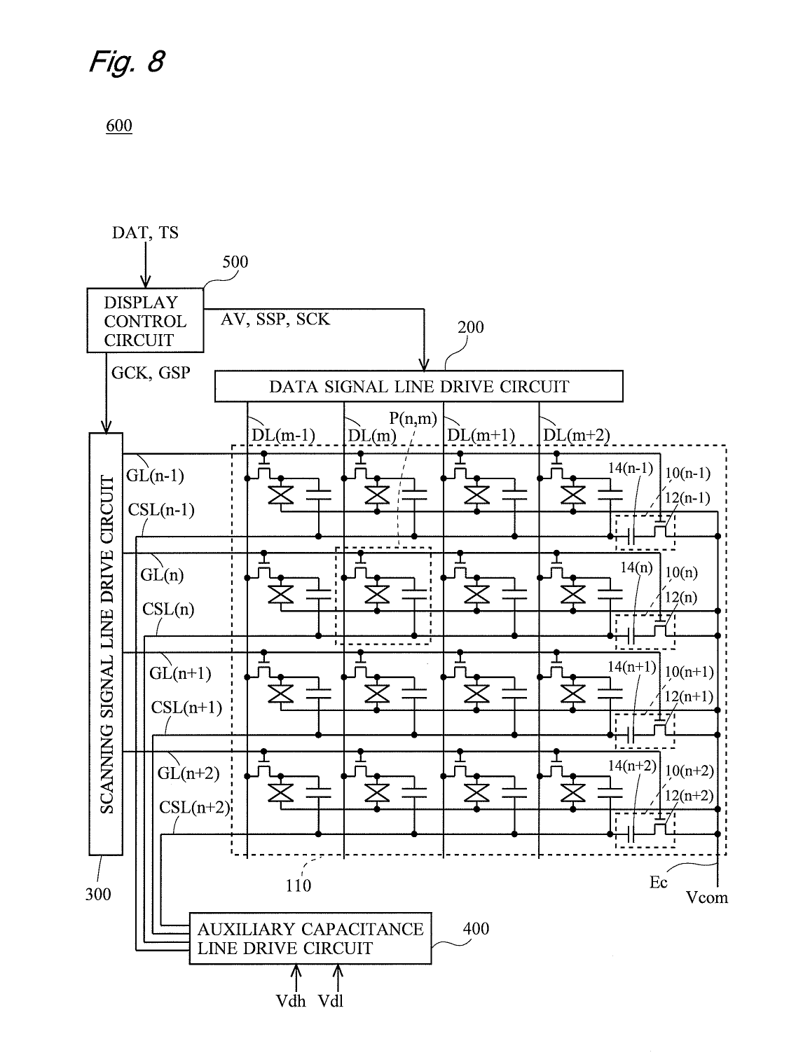

The connection order between the correction TFT 12 and the capacitor 14 may be reversed. That is, as shown in FIG. 8, the source electrode of the correction TFT 12 in the smoothing part 10, and the auxiliary capacitance line CSL arranged along the scanning signal line GL corresponding to the smoothing part 10 may be connected to each other through the capacitor 14 in the smoothing part 10, and the drain electrode of the correction TFT 12 in the smoothing part 10 and the common electrode Ec may be connected to each other.

### 2. Second Embodiment

### 2.1 Configuration of Liquid Crystal Display Device

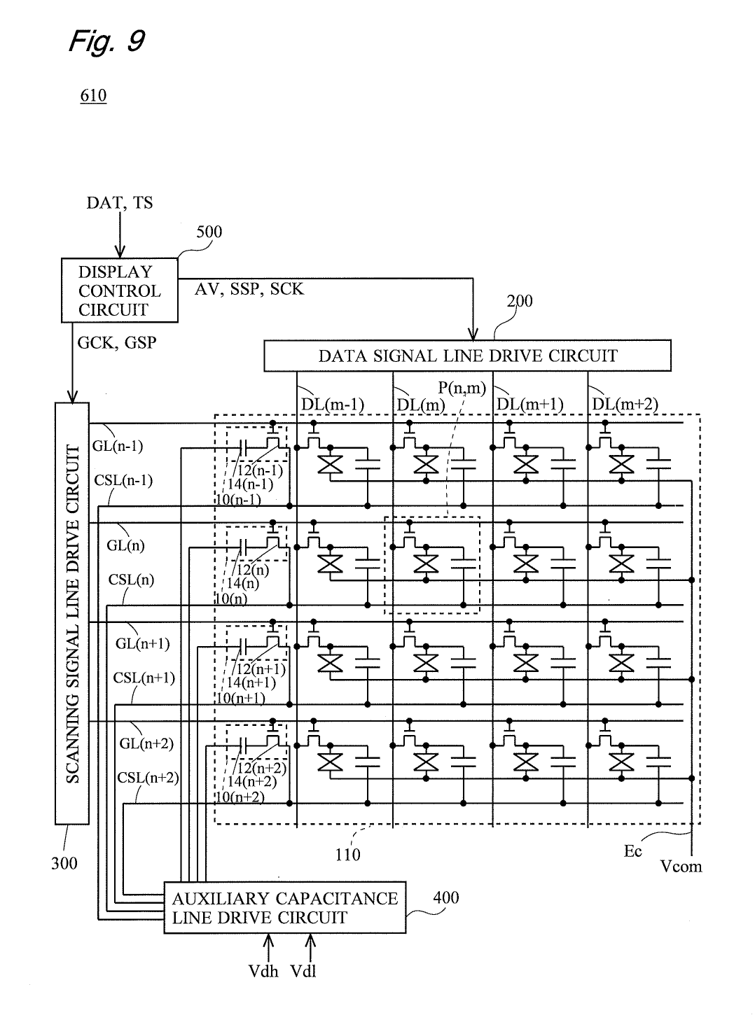

FIG. 9 is a circuit diagram showing an electric configuration of a liquid crystal display device 610 according to a second embodiment of the present invention. The liquid crystal display device 610 according to present embodiment includes a display panel 110 in place of the display panel 100 included in the liquid crystal display device 600 according to the first embodiment. Of components of the present embodiment, the same components as those of the first embodiment are denoted by the same reference characters, and descriptions thereof are omitted.

### 2.2 Configuration of Display Panel

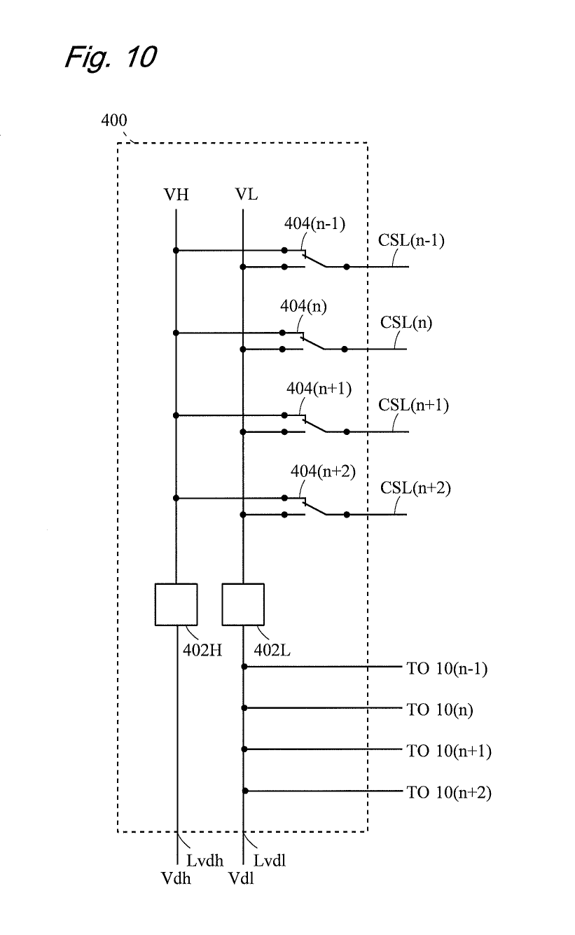

In the display panel 110 in the present embodiment, unlike the display panel 100 in the first embodiment, smoothing parts 10 are provided on an input end side of auxiliary capacitance lines CSL (in FIG. 9, on the left side in the display panel 110). A position of each of the smoothing parts 10 is not limited to the input end side of each of the auxiliary capacitance lines CSL, but may be the output end side of each of the auxiliary capacitance lines CSL (in FIG. 9, on the right side in the display panel 110). Through the smoothing part 10, the auxiliary capacitance line CSL arranged along a corresponding scanning signal line GL, and an L-side power supply line Lvdl as a wiring to which a fixed potential is supplied when the scanning signal line GL is in a selected state are connected to each other. That is, as shown in FIG. 10, the L-side power supply line Lvdl and the respective smoothing parts 10 are connected to one another.

A source electrode as one of conduction terminals of a correction TFT 12 in the smoothing part 10, and the auxiliary capacitance line CSL arranged along the scanning signal line GL corresponding to the smoothing part 10 are connected to each other, and a drain electrode as the other of the conduction terminals of the correction TFT 12 in the smoothing part 10 and the L-side power supply line Lvdl are connected to each other through a capacitor 14 in the smoothing part 10. For example, a source electrode of a correction TFT 12(n) in a smoothing part 10(n) and an auxiliary capacitance line CSL(n) are connected to each other, and a drain electrode of the correction TFT 12(n) and the L-side power supply line Lvdl are connected to each other through a capacitor 14(n).

A gate electrode of the correction TFT 12 in each of the smoothing parts 10 as a control terminal is connected to the scanning signal line GL corresponding to the smoothing part 10. For example, a gate electrode of the correction TFT 12(n) in the smoothing part 10(n) is connected to a scanning signal line GL(n). The correction TFT 12(n) is controlled so as to enter a conductive state when the scanning signal line GL(n) is in a selected state, and enter a shut state when the scanning signal line GL(n) is in a non-selected state.

### 2.3 Operation

In the present embodiment, when the scanning signal line GL(n) is in the selected state, a high frequency component (corresponding to potential fluctuation) of an auxiliary capacitance signal applied to the auxiliary capacitance line CSL(n) is supplied through the capacitor 14(n) to the L-side power supply line Lvdl to which an L-side power supply potential Vdl as a fixed potential is supplied, which reduces a magnitude of a potential fluctuation ΔV as compared with the conventional device. Other operations in the present embodiment are similar to those of the first embodiment, and thus, descriptions thereof are omitted.

### 2.4 Effects

According to the present embodiment, when the scanning signal line GL(n) is in the selected state, the L-side power supply line Lvdl to which the L-side power supply potential Vdl as the fixed potential is supplied, and the auxiliary capacitance line CSL(n) are electrically connected through the capacitor 14(n). This can exert effects similar to those of the first embodiment.

In place of the L-side power supply line Lvdl, an H-side power supply line Lvdh and the respective smoothing parts 10 may be connected to one another. Alternatively, the L-side power supply line Lvdl and the H-side power supply line Lvdh, and the respective smoothing parts 10 may be connected to one another. Furthermore, in place of the L-side power supply line Lvdl, either or both of a wiring to which a low potential VL is supplied and a wiring to which a high potential VH is supplied may be connected to the respective smoothing parts 10.

Moreover, as in the first embodiment, the connection order between the correction TFT 12 and the capacitor 14 may be reversed.

### 3. Third Embodiment

### 3.1 Configuration of Liquid Crystal Display Device

FIG. 11 is a circuit diagram showing an electric configuration of a liquid crystal display device 620 according to a third embodiment of the present invention. The liquid crystal display device 620 according to present embodiment includes a display panel 120 in place of the display panel 100 included in the liquid crystal display device 600 according to the first embodiment. Of components of the present embodiment, the same components as those of the first embodiment are denoted by the same reference characters, and descriptions thereof are omitted.

### 3.2 Configuration of Display Panel

In the display panel 120 in the present embodiment, unlike the display panel 100 in the first embodiment, an auxiliary capacitance line CSL arranged along a corresponding scanning signal line GL, and an auxiliary capacitance line CSL arranged along a precedent scanning signal line GL of the scanning signal line GL in a scanning direction (a first direction) are connected to each other through a smoothing part 10. For example, through a smoothing part 10(n), an auxiliary capacitance line CSL(n) arranged along a corresponding scanning signal line GL(n), and an auxiliary capacitance line CSL(n−1) arranged along a precedent scanning signal line GL(n−1) of the scanning signal line GL(n) in the first direction are connected to each other.

A source electrode as one of conduction terminals of a correction TFT 12 in the smoothing part 10, and the auxiliary capacitance line CSL arranged along the scanning signal line GL corresponding to the smoothing part 10 are connected to each other through a capacitor 14 in the smoothing part 10, and a drain electrode as the other of the conduction terminals of the correction TFT 12 in the smoothing part 10 and the auxiliary capacitance line CSL arranged along the precedent scanning signal line GL of the scanning signal line GL corresponding to the smoothing part 10 in the first direction are connected to each other. For example, a source electrode of a correction TFT 12(n) in the smoothing part 10(n) and the auxiliary capacitance line CSL(n) are connected to each other through a capacitor 14(n), and a drain electrode of the correction TFT 12(n) and an auxiliary capacitance line CSL(n−1) are connected to each other.

A gate electrode of the correction TFT 12 in each of the smoothing parts 10 as a control terminal is connected to the scanning signal line GL corresponding to the smoothing part 10. For example, a gate electrode of the correction TFT 12(n) in the smoothing part 10(n) is connected to the scanning signal line GL(n). The correction TFT 12(n) is controlled so as to enter a conductive state when the scanning signal line GL(n) is in a selected state, and enter a shut state when the scanning signal line GL(n) is in a non-selected state.

### 3.3 Operation

In a first frame period TF1, when the scanning signal line GL(n) is in the selected state, a high frequency component (corresponding to potential fluctuation) of an auxiliary capacitance signal (a low potential VL) applied to the auxiliary capacitance line CSL(n) is supplied through the capacitor 14(n) to the auxiliary capacitance line CSL(n−1) to which the low potential VL as a fixed potential is supplied in the selected state (FIG. 3(D)), which reduces a magnitude of a potential fluctuation ΔV as compared with the conventional device. In a second frame period TF2, potentials of the auxiliary capacitance line CSL(n) and the auxiliary capacitance line CSL(n−1) become a high potential VH.

### 3.4 Effects

According to the present embodiment, when the scanning signal line GL(n) is in the selected state, the auxiliary capacitance line CSL(n−1) to which the high potential VH (or the low potential VL) as the fixed potential is supplied, and the auxiliary capacitance line CSL(n) are electrically connected through the capacitor 14(n). This can exert effects similar to those of the first embodiment.

When the scanning signal line GL(n) is in the selected state, it is only required that the auxiliary capacitance line CSL(n) and the auxiliary capacitance line CSL arranged along the other scanning signal line GL in the non-selected state are connected to each other. Accordingly, for example, when the scanning signal line GL(n) is in the selected state, the auxiliary capacitance line CSL(n) and an auxiliary capacitance line CSL(n+2) may be connected to each other. Alternatively, when the scanning signal line GL(n) is in the selected state, the auxiliary capacitance line CSL(n), the auxiliary capacitance line CSL(n−1), and an auxiliary capacitance line CSL(n+1) may be connected to one another.

Moreover, as in the first embodiment, the connection order between the correction TFT 12 and the capacitor 14 may be reversed.

### 4. Fourth Embodiment

### 4.1 Configuration of Liquid Crystal Display Device

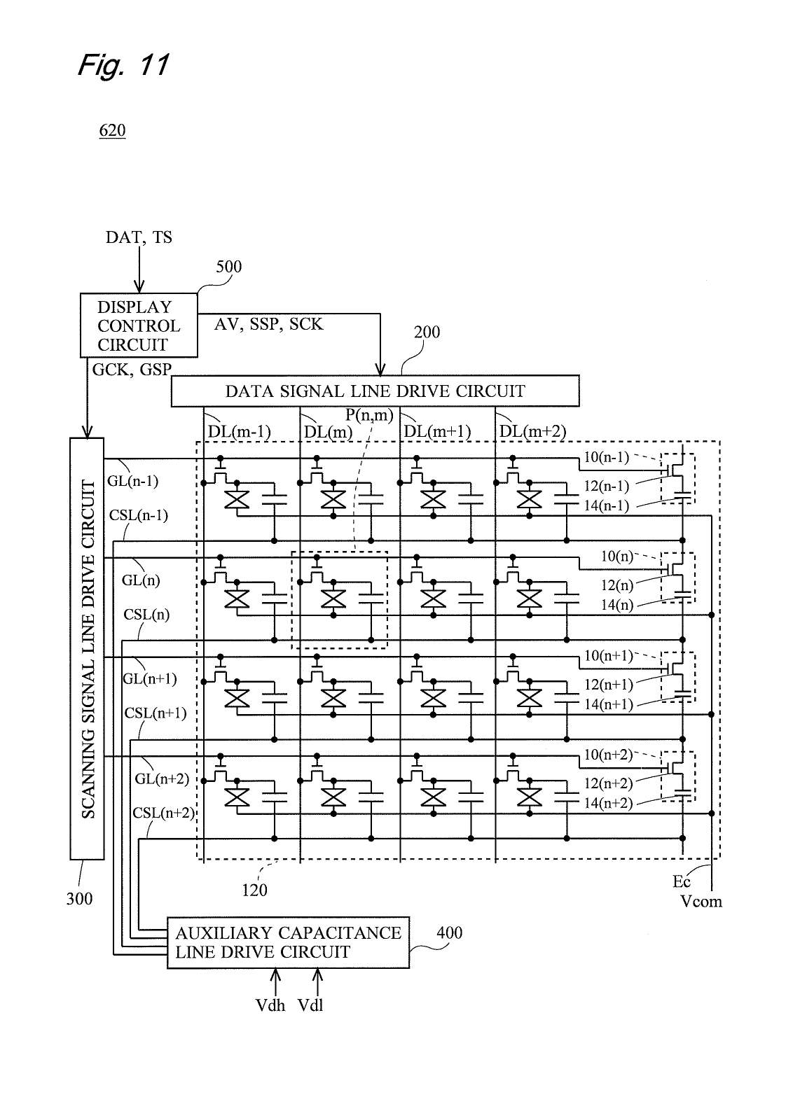

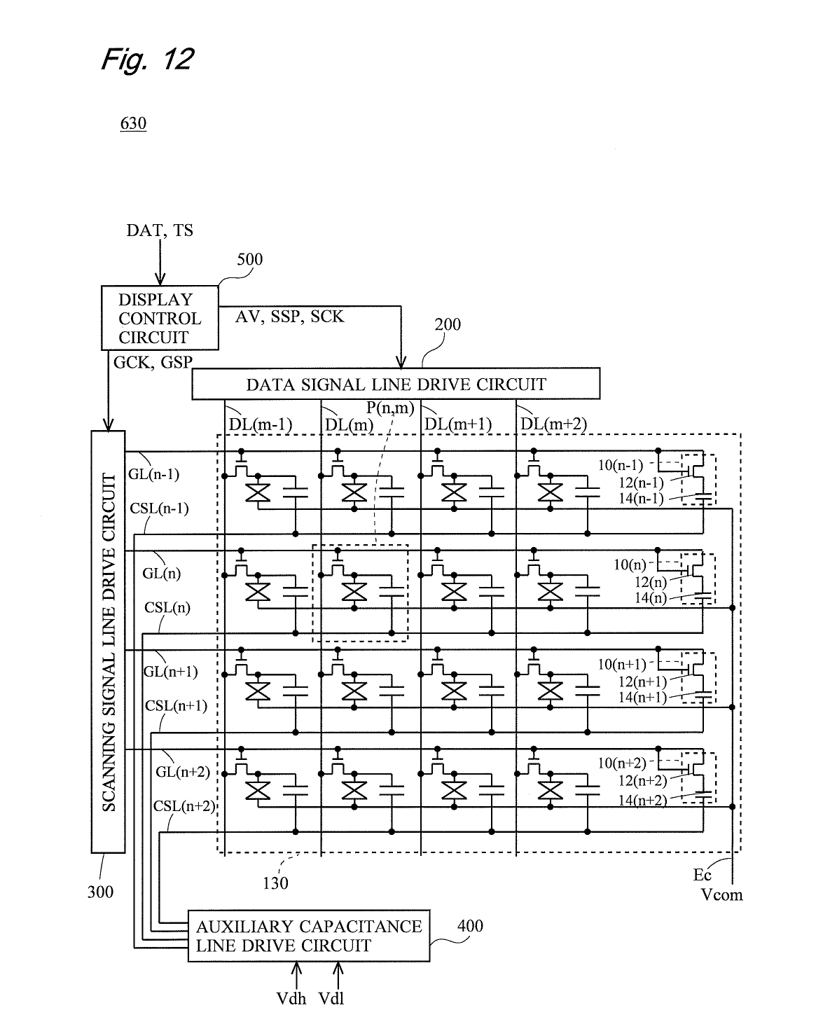

FIG. 12 is a circuit diagram showing an electric configuration of a liquid crystal display device 630 according to a fourth embodiment of the present invention. The liquid crystal display device 630 according to present embodiment includes a display panel 130 in place of the display panel 100 included in the liquid crystal display device 600 according to the first embodiment. Of components of the present embodiment, the same components as those of the first embodiment are denoted by the same reference characters, and descriptions thereof are omitted.

### 4.2 Configuration of Display Panel

In the display panel 130 in the present embodiment, unlike the display panel 100 in the first embodiment, an auxiliary capacitance line CSL arranged along a corresponding scanning signal line GL, and the scanning signal line GL are connected to each other through a smoothing part 10. For example, through a smoothing part 10(n), an auxiliary capacitance line CSL(n) arranged along a corresponding scanning signal line GL(n), and the scanning signal line GL(n) are connected to each other.

A source electrode as one of conduction terminals of a correction TFT 12 in the smoothing part 10, and the auxiliary capacitance line CSL arranged along the scanning signal line GL corresponding to the smoothing part 10 are connected to each other through a capacitor 14 in the smoothing part 10, and a drain electrode as the other of the conduction terminals of the correction TFT 12 in the smoothing part 10, and the scanning signal line GL corresponding to the smoothing part 10 are connected to each other. For example, a source electrode of a correction TFT 12(n) in the smoothing part 10(n), and the auxiliary capacitance line CSL(n) are connected to each other through a capacitor 14(n), and a drain electrode of the correction TFT 12(n) and the scanning signal line GL(n) are connected to each other.

A gate electrode of the correction TFT 12 in each of the smoothing parts 10 as a control terminal is connected to the scanning signal line GL corresponding to the smoothing part 10. For example, a gate electrode of the correction TFT 12(n) in the smoothing part 10(n) is connected to the scanning signal line GL(n). The correction TFT 12(n) is controlled so as to enter a conductive state when the scanning signal line GL(n) is in the selected state, and enter a shut state when the scanning signal line GL(n) is in a non-selected state.

### 4.3 Operation

When the scanning signal line GL(n) is in the selected state, a high frequency component (corresponding to potential fluctuation) of an auxiliary capacitance signal applied to the auxiliary capacitance line CSL(n) is supplied through the capacitor 14(n) to the scanning signal line GL(n) to which a scanning signal as a fixed potential (a potential that puts pixel TFTs 101 into a conductive state at this time) is supplied in the selected state. This reduces a magnitude of a potential fluctuation ΔV as compared with the conventional device. A potential of the scanning signal line GL(n) in the selected state is higher than a potential of the auxiliary capacitance line CSL(n).

Other operations in the present embodiment are similar to those of the first embodiment, and thus, descriptions thereof are omitted.

### 4.4 Effects

According to the present embodiment, when the scanning signal line GL(n) is in the selected state, the scanning signal line GL(n) to which the scanning signal as the fixed potential is supplied, and the auxiliary capacitance line CSL(n) are electrically connected through the capacitor 14(n). This can exert effects similar to those of the first embodiment.

Moreover, as in the first embodiment, the connection order between the correction TFT 12 and the capacitor 14 may be reversed.

### 5. Others

In view of removal of the high frequency component of the auxiliary capacitance signal, an on-resistance of the correction TFT 12 in the above-described embodiments and modifications is desired to be as small as possible.

While in each of the above-described embodiments, one smoothing part 10 is provided for each of the scanning signal lines GL, a plurality of smoothing parts may be provided. Moreover, the above-described embodiments and modifications may be used in combination. Furthermore, each of the smoothing parts 10 may have a plurality of capacitors 14.

While in each of the above-described embodiments, the smoothing parts 10 are provided as the components of the display panel 100, the present invention is not limited thereto. For example, in the second embodiment, the smoothing parts 10 may be provided inside the auxiliary capacitance line drive circuit 400.

While in the foregoing description, examples in which the display is performed in the normally black mode are taken, effects similar to those of each of the above-described embodiments can be also obtained when the display is performed in a normally white mode.

Various modifications can be made within a range not departing from the gist of the present invention.

As described above, according to the present invention, the display device capable of suppressing the horizontal crosstalk while reducing power consumption can be provided.

### INDUSTRIAL APPLICABILITY

The present invention can be applied to an active matrix-type display device using switching elements such as thin film transistors.

1. A display device, comprising:
a plurality of data signal lines to which a plurality of data signals that represent an image to be displayed are applied, respectively;
a plurality of scanning signal lines that intersect the plurality of data signal lines, and are driven selectively by being respectively applied a plurality of scanning signals;
a plurality of pixel circuits arranged in a matrix shape, corresponding to intersections between the plurality of data signal lines and the plurality of scanning signal lines, respectively;
a plurality of auxiliary capacitance lines arranged along the plurality of scanning signal lines, respectively;
an auxiliary capacitance line drive circuit that applies, to the plurality of auxiliary capacitance lines, a plurality of auxiliary capacitance signals to drive the auxiliary capacitance lines independently from one another, respectively; and
smoothing parts provided, corresponding to the respective scanning signal lines, wherein each of the pixel circuits includes:
a first switching element that enters a conductive state when the scanning signal line passing through a corresponding intersection is in a selected state, and enters a shut state when the scanning signal line is in a non-selected state;
a pixel electrode that is connected to the data signal line passing through the corresponding intersection through the first switching element;
a common electrode provided commonly to the plurality of pixel circuits; and
an auxiliary capacitance formed between the pixel electrode and the auxiliary capacitance line arranged along the scanning signal line passing through the corresponding intersection,
after the scanning signal line is switched from the selected state to the non-selected state, the auxiliary capacitance line drive circuit changes a potential of the auxiliary capacitance signal applied to the auxiliary capacitance line arranged along the scanning signal line,
each of the smoothing parts is made up of a second switching element that is controlled so as to enter a conductive state when the scanning signal line corresponding to the smoothing part is in the selected state, and enter a shut state when the scanning signal line is in the non-selected state, and a capacitive element connected to any of conduction terminals of the second switching element, and
through each of the smoothing parts, the auxiliary capacitance line arranged along the scanning signal line corresponding to the smoothing part, and a wiring to which a fixed potential is supplied when the scanning signal line corresponding to the smoothing part is in the selected state are connected to each other.

2. The display device according to claim 1,
wherein one of the conduction terminals of the second switching element in each of the smoothing parts, and the auxiliary capacitance line arranged along the scanning signal line corresponding to the smoothing part are connected to each other, and
the other of the conduction terminals of the second switching element in each of the smoothing parts, and the wiring are connected to each other through the capacitive element in the smoothing part.

3. The display device according to claim 1,
wherein one of the conduction terminals of the second switching element in each of the smoothing parts, and the auxiliary capacitance line arranged along the scanning signal line corresponding to the smoothing part are connected to each other through the capacitive element in the smoothing part, and
the other of the conduction terminals of the second switching element in each of the smoothing parts, and the wiring are connected to each other.

4. The display device according to claim 2, wherein the wiring is the common electrode.

5. The display device according to claim 2, wherein the wiring is a power supply line that supplies power to generate the plurality of auxiliary capacitance signals.

6. The display device according to claim 2, wherein the wiring is the auxiliary capacitance line arranged along the scanning signal line in the non-selected state.

7. The display device according to claim 2, wherein the wiring is the scanning signal line in the selected state.

8. The display device according to claim 3, wherein the wiring is the common electrode.

9. The display device according to claim 3, wherein the wiring is a power supply line that supplies power to generate the plurality of auxiliary capacitance signals.

10. The display device according to claim 3, wherein the wiring is the auxiliary capacitance line arranged along the scanning signal line in the non-selected state.

11. The display device according to claim 3, wherein the wiring is the scanning signal line in the selected state.
